(19) United States
(12) Patent Application Publication
(10) Pub. No.: US 2026/0208042 A1
(43) Pub. Date: Jul. 23, 2026

(54) VISUAL DATA PROCESSING AND ADAPTIVE INPUT GENERATION IN DYNAMIC VIRTUAL ENVIRONMENTS

(71) Applicant: NVIDIA Corporation, Santa Clara, CA (US)

(72) Inventor: Sagar CHAKOLE, Pune (IN)

(73) Assignee: NVIDIA Corporation, Santa Clara, CA (US)

(21) Appl. No.: 19/034,338

(22) Filed: Jan. 22, 2025

(51) Int. Cl. A63F 13/52; A63F 13/56

(52) U.S. Cl. CPC A63F 13/52; A63F 13/56; A63F 2300/8082

(57) ABSTRACT

Various examples, systems, and methods are disclosed relating to a vision pipeline. A first computing system can capture at least one frame of an application. The first computing system further can apply the at least one frame to at least one vision language model (VLM) to cause the at least one VLM to generate at least one scene description. The first computing system further can retrieve a set of embeddings based at least on a similarity metric between the generated at least one scene description and the set of embeddings. The first computing system further can apply the set of embeddings to at least one language model (LM) to cause the at least one LM to generate at least one input command corresponding with updating a position or action of the avatar. The first computing system further can perform the at least one input command within the application.

### BACKGROUND

Automating navigation and input generation in virtual environments presents challenges. Some traditional methods rely on static rules and predefined scripts for processing visual inputs, leading to inefficiencies and reduced adaptability. This approach can result in limited system performance and an inability to handle varying or dynamic virtual environments. Current systems are inadequate at dynamically processing scene descriptions and generating adaptive input commands without requiring extensive manual scripting or training. Additionally, traditional machine learning approaches often rely on large-scale datasets and lengthy training processes, reducing their practicality for systems requiring real-time or near real-time decision-making. This approach can result in static command generation and an inability to adapt to variable visual conditions in virtual environments. Challenges in implementing real-time (or near real-time) scene analysis and adaptive input generation create inefficiencies, affecting the accuracy and computational efficiency of navigating dynamic virtual environments (e.g., gaming environments or simulation frameworks).

### SUMMARY

Implementations of the present disclosure relate to systems and methods for improving automated navigation and input generation in virtual environments using artificial intelligence (AI) models. Systems and methods are disclosed that can utilize AI and/or machine learning (ML) models (e.g., vision language models (VLMs), small language models (SLMs), large language models (LLMs), multi-modal language models (MMLMs)) and real-time scene analysis to generate adaptive input commands. The AI and/or ML models can process real-time (or near real-time) visual data (e.g., frames captured from virtual environments) to generate scene descriptions, retrieve contextual embeddings from a database, and adaptively generate input commands for avatars. For example, systems and methods in accordance with the present disclosure can capture visual data from virtual environments, generate scene descriptions, retrieve embeddings from a vector database, and generate input commands that update a position or action of an avatar. Additionally, the systems and methods can analyze visual anomalies (e.g., rendering inconsistencies or object behavior anomalies) and update inputs based at least in part on the detected anomalies to facilitate navigation. By leveraging stored contextual data and real-time (or near real-time) scene analysis, the disclosed systems and methods improve input command generation and navigation performance in virtual environments without relying on predefined scripts or extensive manual training.

Some implementations relate one or more processors including one or more circuits. The one or more circuits capture at least one frame of an application corresponding with a viewpoint of an avatar in a virtual environment. The one or more circuits apply the at least one frame to at least one vision language model (VLM) to cause the at least one VLM to generate at least one scene description based at least in part on the at least one frame. The one or more circuits retrieve a set of embeddings based at least on a similarity metric between the generated at least one scene description and the set of embeddings, the set of embeddings including at least one corresponding input command of the avatar. The one or more circuits apply the set of embeddings to at least one large language model (LLM) to cause the at least one LLM to generate at least one input command of the avatar corresponding with updating at least one of a position or action of the avatar in the application. The one or more circuits perform the at least one input command within the application to update at least one of the position or action of the avatar.

In some implementations, the one or more circuits are to identify application data of the application. In some implementations, the one or more circuits are to map a plurality of frames of the application data to a plurality of avatar inputs. In some implementations, the one or more circuits are to generate, using the at least one VLM, a plurality of scene descriptions corresponding to the plurality of frames. In some implementations, the one or more circuits are to generate the set of embeddings including a plurality of vectors, the plurality of vectors including the plurality of scene descriptions and corresponding avatar inputs of the plurality of avatar inputs. In some implementations, the one or more circuits are to store the set of embeddings in a vector database. In some implementations, retrieving the set of embeddings includes identifying at least one vector of the plurality of vectors corresponding to at least one stored scene description of the plurality of scene descriptions. In some implementations, the at least one vector includes the corresponding avatar inputs of the at least one stored scene description.

In some implementations, the one or more circuits are to initiate execution of a capture script to record a plurality of input events and corresponding timestamps during at least one game session of the application, the execution of the capture script including capturing the at least one frame and a plurality of additional frames. In some implementations, the one or more circuits are to record the plurality of input events and corresponding timestamps to generate a log of a plurality of input commands performed by the avatar during the at least one game session. In some implementations, the one or more circuits are to apply at least one second VLM to cause the at least one second VLM to identify at least one visual anomaly within the virtual environment of the application. In some implementations, identifying the at least one visual anomaly includes the at least one second VLM detecting at least one inconsistency in at least one of physics interaction, object behavior, or visual rendering during the game session. In some implementations, the one or more circuits are to associate the at least one visual anomaly with a corresponding input event of the plurality of input events, wherein the log includes the at least one visual anomaly.

In some implementations, the one or more circuits are to continuously capture, in real-time or near real-time, the plurality of additional frames during the at least one game session, wherein the at least one frame is captured responsive to receiving a start command in the application. In some implementations, the one or more circuits are to generate, using at least one neural network, a quality score of at least one of the position or action of the avatar. In some implementations, the at least one input command is performed responsive to the quality score satisfying a predetermined threshold.

In some implementations, the update to at least one of the position or action of the avatar includes avoiding a visual obstacle within the virtual environment of the application. In some implementations, the application generates the at least one frame of a rendering in the virtual environment. In some implementations, the at least one scene description generated by the at least one VLM identifies at least one object or environmental feature within the virtual environment. In some implementations, retrieving the set of embeddings includes using retrieval-augmented generation (RAG), and wherein the at least one input command is agnostic to the application or a game engine executing the application.

Some implementations relate a system including one or more processors. The one or more processors cause at least one first model to generate at least one scene description based at least in part on at least one frame of an application corresponding to an avatar in an environment. The one or more processors retrieve a set of embeddings based at least on a similarity metric between the generated at least one scene description and the set of embeddings, the set of embeddings including at least one corresponding input command of the avatar. The one or more processors cause at least one second model to generate at least one input command of the avatar corresponding with updating at least one of a position or action of the avatar in the application based at least on the set of embeddings including the at least one corresponding input command. The one or more processors perform the at least one input command within the application to update at least one of the position or action of the avatar.

In some implementations, the one or more processors are to identify application data of the application. In some implementations, the one or more processors are to map a plurality of frames of the application data to a plurality of avatar inputs. In some implementations, the one or more processors are to generate, using the at least one first model, a plurality of scene descriptions corresponding to the plurality of frames. In some implementations, the one or more processors are to generate the set of embeddings including a plurality of vectors, the plurality of vectors including the plurality of scene descriptions and corresponding avatar inputs of the plurality of avatar inputs. In some implementations, the one or more processors are to store the set of embeddings in a vector database. In some implementations, retrieving the set of embeddings includes identifying at least one vector of the plurality of vectors corresponding to at least one stored scene description of the plurality of scene descriptions. In some implementations, the at least one vector includes the corresponding avatar inputs of the at least one stored scene description.

In some implementations, the one or more processors are to initiate execution of a capture script to record a plurality of input events and corresponding timestamps during at least one session of the application, the execution of the capture script including capturing the at least one frame and a plurality of additional frames. In some implementations, the one or more processors are to record the plurality of input events and corresponding timestamps to generate a log of a plurality of input commands performed by the avatar during the at least one session. In some implementations, the one or more processors are to apply at least one third model to cause the at least one third model to identify at least one visual anomaly of the application. In some implementations, identifying the at least one visual anomaly includes the at least one third model detecting at least one inconsistency in at least one of physics interaction, object behavior, or visual rendering during a game session. In some implementations, the one or more processors are to associate the at least one visual anomaly with a corresponding input event of the plurality of input events, wherein the log includes the at least one visual anomaly.

In some implementations, the one or more processors are to continuously capture, in real-time or near real-time, the plurality of additional frames during the at least one session. In some implementations, the at least one frame is captured responsive to receiving a start command in the application. In some implementations, the one or more processors are to generate, using at least one neural network, a quality score of at least one of the position or action of the avatar. In some implementations, the at least one input command is performed responsive to the quality score satisfying a predetermined threshold. In some implementations, the update to at least one of the position or action of the avatar includes avoiding a visual obstacle of the application.

Some implementations relate to a method. The method includes generating, by one or more processors, at least one scene description based at least in part on at least one frame corresponding to a state within an application. The method includes obtaining, by the one or more processors, at least one embedding for the generated at least one scene description based at least on a similarity metric between the generated at least one scene description and the at least one embedding. The method includes applying, by the one or more processors, the at least one embedding to at least one model to generate at least one command to update the state within the application. The method includes executing the at least one command to update the state within the application.

The processors, systems, and/or methods described herein can be implemented by or included in at least one a control system for an autonomous or semi-autonomous machine, a perception system for an autonomous or semi-autonomous machine, a system implemented using a robot, an aerial system, a medical system, a boating system, a smart area monitoring system, a system for performing deep learning operations, a system for performing simulation operations, a system for generating or presenting virtual reality (VR) content, augmented reality (AR) content, or mixed reality (MR) content, a system for performing digital twin operations, a system implemented using an edge device, a system incorporating one or more virtual machines (VMs), a system for generating synthetic data, a system implemented at least partially in a data center, a system for performing conversational artificial intelligence (AI) operations, a system for performing generative AI operations, a system implementing language models, a system implementing vision language models (VLMs), a system implementing large language models (LLMs), a system implementing small language models (SLMs), a system implementing multi-modal language models (MMLMs), a system for hosting one or more real-time streaming applications, a system for performing light transport simulation, a system for performing collaborative content creation for 3D assets, and/or a system implemented at least partially using cloud computing resources.

### BRIEF DESCRIPTION OF THE DRAWINGS

The present systems and methods for visual data processing and adaptative input generation dynamic virtual environments are described in detail below with reference to the attached drawing figures, wherein:

FIG. 1 is a block diagram of an example of a system, in accordance with some implementations of the present disclosure;

FIG. 2 is a flow diagram of an example of a method for visual data processing and adaptative input generation in a vision pipeline, in accordance with some implementations of the present disclosure;

FIG. 3 is a block diagram of an example training and command generation process, in accordance with some implementations of the present disclosure;

FIG. 4 is an example illustration of a virtual environment, in accordance with some implementations of the present disclosure;

FIG. 5A is a block diagram of an example generative language model system suitable for use in implementing at least some implementations of the present disclosure;

FIG. 5B is a block diagram of an example generative language model that includes a transformer encoder-decoder suitable for use in implementing at least some implementations of the present disclosure;

FIG. 5C is a block diagram of an example generative language model that includes a decoder-only transformer architecture suitable for use in implementing at least some implementations of the present disclosure;

FIG. 6 is a block diagram of an example computing device suitable for use in implementing at least some implementations of the present disclosure; and

FIG. 7 is a block diagram of an example data center suitable for use in implementing at least some implementations of the present disclosure.

### DETAILED DESCRIPTION

This disclosure relates to systems and methods for automated navigation and input generation in virtual environments using machine learning models (e.g., vision language models (VLMs) and language models (LMs)) for real-time (or near real-time) scene understanding and predictive input generation based at least in part on visual data. Existing computer vision-based automation and scripting solutions (e.g., image recognition tools, automation scripting systems) are typically constrained to surface-level visual cues, limiting the effectiveness in processing environments with high variability or dynamic elements where contextual decision-making and adaptability can enhance performance. For example, some automation systems can process static or predictable visual elements but demonstrate reduced efficiency when operating in virtual environments with unpredictable or dynamic conditions.

Traditional machine learning approaches (e.g., reinforcement learning, imitation learning) are often employed for training AI agents within simulation environments (e.g., virtual simulation frameworks). However, these approaches typically utilize large datasets, require extensive training time, and often cannot be optimized for real-time (or near real-time) scene analysis or predictive input generation. Additionally, predefined scripts or commands in game engine scripting systems (e.g., virtual environment APIs) are generally constrained by static rules and do not update inputs based at least in part on real-time (or near real-time) visual data, which reduces their applicability in dynamic virtual environments.

Systems and methods in accordance with the present disclosure facilitate improved automation performance by providing real-time (or near real-time) scene analysis and predictive input generation. For example, the disclosed implementations can capture frames from a virtual environment (e.g., virtual worlds, gaming environments, digital twin environments, augmented reality (AR) settings, virtual reality (VR) simulations, or other immersive digital experiences) and process the frames using a VLM to generate at least one scene description. The scene description can be compared to embeddings stored in a database (e.g., vector database). That is, the database can store previously generated scene descriptions and corresponding inputs, facilitating the retrieval of relevant contextual data and generation of adaptive input commands. In contrast to static scripting systems or tools constrained to visual cues, the disclosed implementations can integrate real-time (or near real-time) visual data with contextual knowledge to dynamically navigate variable environments.

For example, the systems and methods can capture a frame of the virtual environment corresponding to the viewpoint of an avatar. The captured frame can be processed by the VLM to generate a scene description that can include object and environmental features. The description can be compared against stored embeddings using a similarity metric (e.g., cosine similarity, Euclidean distance, Hamming distance), retrieving embeddings that represent prior scene descriptions and associated inputs. The retrieved embeddings can provide contextual data to the language model (e.g., a large language model (LLM)), which can generate input commands, allowing the avatar to modify its movement or actions in response to the current visual environment. The disclosed systems and methods improve upon traditional automation tools by facilitating adaptive input generation without reliance on predefined scripting or extensive manual training. The configurations of the systems to process real-time visual data and generate dynamic inputs facilitates improved navigation in virtual environments without requiring continuous manual oversight. By utilizing stored scene descriptions and associated inputs, the systems can generalize across various virtual environments or game genres, providing a scalable and adaptable technical solution.

For example, systems dependent on predefined scripts lack adaptability when processing dynamic or unfamiliar environments, reducing their operational effectiveness. In contrast, the disclosed systems can continuously analyze the current scene and retrieve relevant contextual data, allowing adaptive input generation based at least in part on real-time (or near real-time) visual analysis. This can allow avatars to navigate non-static environments without requiring continuous manual intervention or retraining. In another example, traditional automation tools can often be constrained to static inputs or simple visual recognition tasks, limiting the tools' capacity to interpret and respond to scene dynamics. By incorporating machine learning models (e.g., VLMs and LMs), the disclosed systems and methods can analyze visual data, generate context-aware input commands, and adaptively respond to dynamic environments, providing a performance improvement over systems that rely on static scripts or surface-level visual cues. Thus, the disclosed system offers scene understanding, predictive input generation, and efficient navigation in dynamic virtual environments, addressing the technical limitations of traditional computer vision-based systems, machine learning approaches, and predefined script-based solutions.

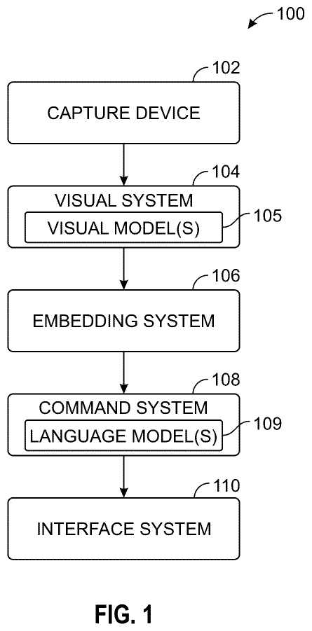

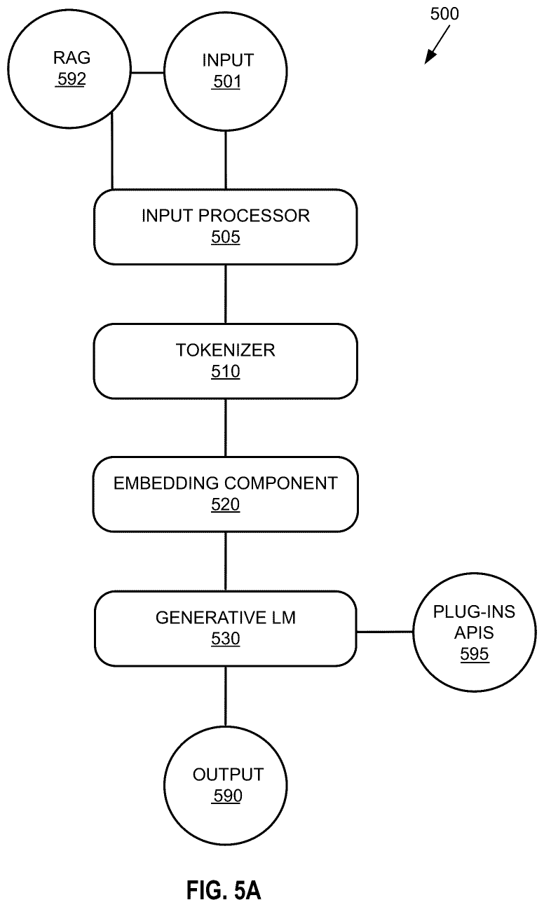

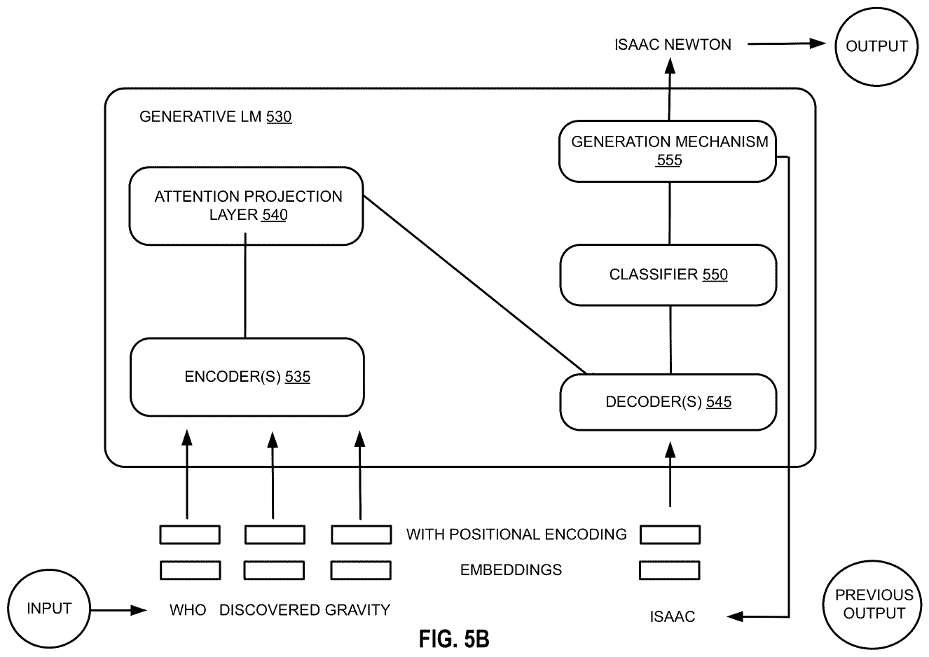

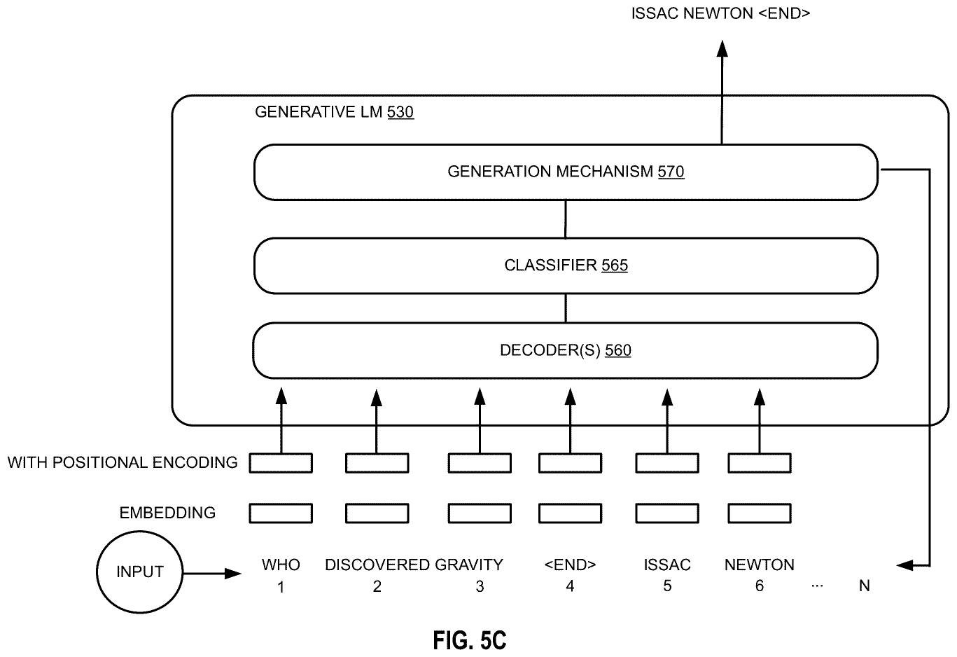

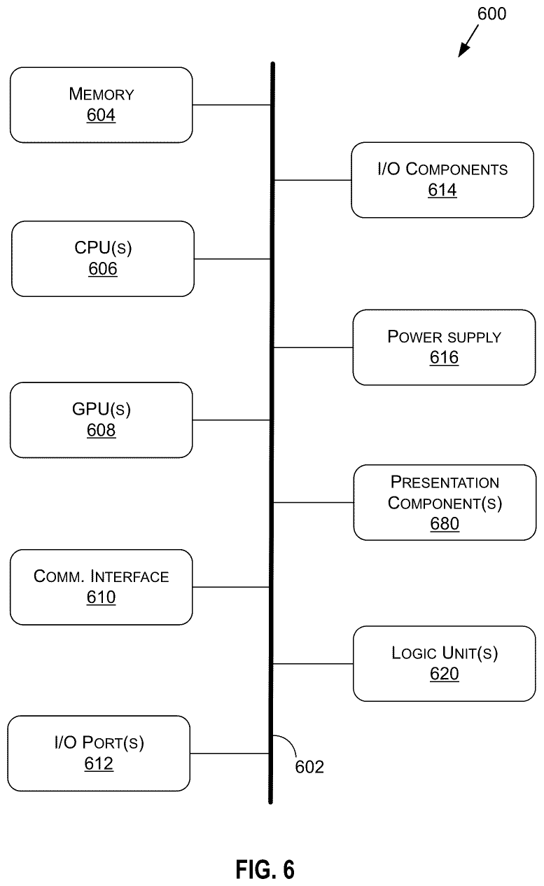

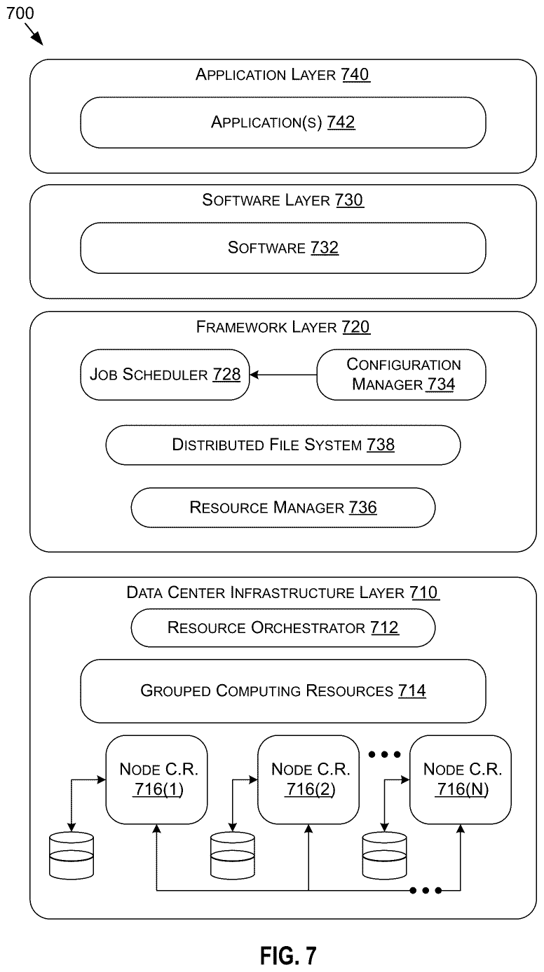

With reference to FIG. 1, FIG. 1 is an example block diagram of a system 100, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out by a processor executing instructions stored in memory. In some implementations, the systems, methods, and processes described herein can be executed using similar components, features, and/or functionality to those of example generative language model system 500 of FIG. 5A, example generative language model (LM) 530 of FIGS. 5B-5C, example computing device 600 of FIG. 6, and/or example data center 700 of FIG. 7.

The system 100 can implement at least a portion of the vision pipeline, such as a capturing pipeline, a modeling pipeline, an embedding pipeline, or a command generation pipeline. The system 100 can be used to generate adaptive input commands and/or navigate dynamic virtual environments by any of the various systems described herein, including but not limited to gaming systems, simulation systems, testing systems, training systems, anomaly detection systems, debugging systems, and/or performance evaluation systems.

Generally, the vision pipeline can include operations performed by the system 100. For example, the vision pipeline can include any one or more of a capturing stage, a visual modeling stage, an embedding stage, a command modeling stage, and/or an interfacing stage. Each stage of the vision pipeline includes one or more components of the system 100 that perform the functions described herein. In some implementations, one or more of the stages can be performed during the training and/or updating of AI models. Additionally, one or more of the stages can be performed during the inference phase using the AI models.

The system 100 (e.g., implementing the vision pipeline) can include capturing at least one frame of an application corresponding with a viewpoint of an avatar in a virtual environment (e.g., screen capture and/or snapshot of a current scene from a perspective of a player within a game). In some implementations, implementing the vision pipeline can include the system 100 applying the at least one frame to at least one vision language model (VLM) to cause the at least one VLM to generate at least one scene description (e.g., generate textual descriptions of the scene) based at least in part on the at least one frame. Additionally, implementing the vision pipeline can include the system 100 retrieving a set of embeddings (e.g., similar scene descriptions) based at least on a similarity metric (e.g., cosine similarity, Euclidean distance, dot product) between the generated at least one scene description and the set of embeddings, the set of embeddings comprising or otherwise associated with at least one corresponding input command of the avatar.

In some implementations, implementing the vision pipeline can include the system 100 applying the set of embeddings including the at least one corresponding input command (e.g., agnostic of the current scene) to at least one language model (e.g., LLM) to cause the at least one LLM to generate at least one input command (e.g., prediction of a command for a player based at least in part on prior performed actions in similar scenarios) of the avatar corresponding with updating (e.g., movement of the avatar in the simulation) a position or action of the avatar in the application. In some implementations, implementing the vision pipeline can include the system 100 performing the at least one input command (e.g., execute the command, such as moving or interacting with the game) within the application to update the position or action of the avatar. Thus, the command generation pipeline can improve the adaptability and efficiency of input command generation in virtual environments, reducing reliance on predefined scripting and facilitating navigation based at least in part on real-time (or near real-time) scene analysis.

In some implementations, the capturing stage can be the stage in the vision pipeline in which the system 100 can acquire visual data corresponding to the perspective of the avatar. The system 100 can include at least one capture device 102. The capture device 102 can capture at least one frame of an application corresponding with a viewpoint of an avatar in a virtual environment. That is, the capture device 102 can capture and/or otherwise obtain a frame (e.g., screenshot, snapshot, video frame, or a real-time rendered image) of a current scene from a perspective of an avatar (e.g., player) within the application (e.g., game, virtual training system, or simulation platform). For example, during the capturing stage, the capture device 102 can initiate the acquisition of visual data by accessing rendering output from the application.

In some implementations, the capture device 102 can perform capturing by utilizing system calls to the application, accessing the rendering buffer of the application, and/or extracting visual output displayed on a screen. The capture device 102 can be a hardware device, a software module, an API, and/or any component configured to acquire visual data from an application. For example, the capture device 102 can be implemented as a graphics pipeline component within the application or as an external monitoring tool. In this example, the capture device 102 can be configured and/or implemented to capture frames continuously or periodically. In another example, the capture device 102 can be a system-level monitoring system that accesses framebuffer output. In this example, the capture device 102 can be configured and/or implemented to capture rendered frames as the frames are generated by the application. The at least one frame can be a 2D image, a 3D-rendered scene, a video frame, and/or any output generated by the application.

Additionally, the viewpoint of the avatar can be a first-person, third-person, or overhead perspective. The viewpoint generally can refer to the spatial orientation or visual perspective from which the virtual environment is rendered or captured, including the relative position of the camera or observer with respect to the avatar or scene. That is, the viewpoint can be determined by the configuration of the virtual camera within the game engine, such as its angle, distance, or direction relative to the avatar or environment. For example, a first-person viewpoint can place the camera at the eye level of the avatar to simulate direct perspective and a third-person viewpoint can position the camera behind or above the avatar to provide a broader view of the surrounding environment. In some implementations, the viewpoint can represent the visual context from which the avatar interacts with the environment. For example, the capture device 102 can extract a frame representing the line of sight of the avatar in a 3D virtual space.

In some implementations, the capturing stage can include the capture device 102 initiating an execution of a capture script to record a plurality of input events (e.g., keyboard presses, mouse movements, controller inputs, and/or any other user actions). The capture device 102 can execute the capture script to record corresponding timestamps (e.g., when the input event occurred, the duration of the input, and the frame associated with the input) of the input events during a game session (e.g., a level playthrough, a debugging session) of the application. For example, the capture device 102 can monitor input signals generated during the game session. That is, the execution of the capture script by the capture device 102 can include capturing the at least one frame and a plurality of additional frames (e.g., sequences of rendered frames, snapshots at specific time intervals, or frames triggered by input events). In some implementations, the capture device can record the plurality of input events and corresponding timestamps to generate a log. That is, the log can include a plurality of input commands (e.g., keyboard or mouse actions) performed by the avatar during the game session. For example, the log can be a structured dataset, a time-series database, a sequence of labeled input events, and/or any record of input-output mappings.

In some implementations, the capture device 102 can continuously and/or periodically capture the plurality of additional frames during the game session (e.g., in real-time or near real-time). That is, the at least one frame can be captured responsive to receiving a start command (e.g., a game initialization signal, a script execution trigger, or an external monitoring directive) in the application. For example, the capture device 102 can execute frame acquisition functions tied to application states. In some implementations, the application can generate the at least one frame of a rendering in the virtual environment. The rendering can be a fully rendered 3D scene, a wireframe preview, or any intermediate rendering stage. The virtual environment can be a dynamic 3D game world, a training simulation environment, and/or any interactive digital space.

In some implementations, the visual modeling stage can be the stage in the vision pipeline in which the system 100 can process visual input data to extract context and generate scene descriptions. The system 100 can include at least one visual system 104. The visual system 104 can apply the at least one frame to at least one vision language model (VLM) to cause the at least one VLM to generate at least one scene description based at least in part on the at least one frame. In some implementations, applying the frame can include preprocessing the frame to normalize image properties, resizing the frame to fit the input dimensions of the VLM, and encoding the visual data for analysis. The VLM can be a visual model 105 trained and/or implemented to interpret visual data and generate structured textual descriptions of scenes. The visual system 104 can cause the VLM to generate the scene description by processing the frame through layers of the model, including feature extraction and contextual analysis. The scene description can be textual descriptions and/or embeddings of the scene. For example, the scene description can be a summary of objects, spatial relationships, and environmental features. In another example, the scene description can be a structured output containing labels for detected objects and descriptions of interactions. In some implementations, the at least one scene description generated by the at least one VLM (e.g., visual model 105) can identify at least one object or environmental feature within the virtual environment. For example, an object within the virtual environment can be a tree, wall, character, or any interactive element. In another example, an environmental feature within the virtual environment can be a road, mountain, building, or any landscape element.

In some implementations, generating the scene description can be based at least in part on at least one frame corresponding to a state within an application. That is, the state can be a set of conditions defining the environment and elements within the application at a specific moment. For example, the state can be a configuration of objects and interactions within the virtual environment. In another example, the state can be a collection of attributes associated with the current environment, such as object positions or user inputs. Additionally, the frame can correspond to a state by representing visual and contextual data that define the current environment. That is, the state can include dynamic or static features captured through the frame (e.g., capturing the active conditions of the application).

The visual system 104 can include any one or more artificial intelligence (AI) models (e.g., machine learning models, supervised models, neural network models, deep neural network models), rules, heuristics, algorithms, functions, or various combinations thereof to perform operations including feature extraction and contextual understanding, such as generating scene descriptions. That is, visual model 105 can be a transformer-based model, neural network, and/or machine-learning (ML) model trained to interpret visual data and extract semantic context. In some implementations, the visual system 104 can output structured embeddings (e.g., vector representations, labeled descriptions, detected object features, and/or any combinations thereof). For example, the output can be a vector embedding representing the spatial relationships of objects. In another example, the output can be a textual summary of scene components. In some implementations, the frame and/or corresponding frame metadata (e.g., timestamps, resolution, and rendering quality) can be provided by the capture device 102 to visual system 104 to perform scene analysis.

In some implementations, the AI model(s) (e.g., visual model 105) can include any type of transformer-based AI model capable of analyzing scenes and extracting features (e.g., spatial relationships, object properties) to generate structured outputs. For example, visual model 105 can be trained and/or updated to identify objects, classify environmental features, and map spatial relationships, among other scene analysis tasks. The visual model 105 can be or include a transformer-based model (e.g., a generative pre-trained transformer (GPT) model, a bidirectional encoder representations from transformers (BERT)). The AI model(s) can be or include a convolutional model, a recurrent neural network, or a vision-transformer-based architecture, in some implementations. The visual system 104 can execute the visual model 105 to generate outputs. The visual system 104 can receive data to provide as input to the AI model(s), which can include captured frames, preprocessed visual data, embeddings, and/or any related metadata.

In some implementations, the visual system 104 can execute one or more AI models (e.g., model 105) by utilizing a transformer-based framework to improve the performance of the AI model during the training. The framework can include implementing techniques such as gradient descent, backpropagation, and distributed training to process large-scale datasets. For example, during execution, the visual system 104 can partition input data into mini-batches, apply loss functions, and update model parameters iteratively. The AI models can support inference operations that include processing feature vectors, transforming raw input data, and generating probabilistic predictions and/or metrics. The visual system 104 can integrate hardware accelerators such as graphics processing units (GPUs) or tensor processing units (TPUs) to handle computational demands, for example when processing large-scale visual datasets or performing real-time scene analysis. In some implementations, the visual system 104 can evaluate trained models using benchmark metrics (e.g., precision, recall, and/or F1 score) and/or any accuracy-related metrics to determine readiness for deployment and/or inference operations.

In some implementations, the visual model 105 can include an input layer, an output layer, and/or one or more intermediate layers, such as hidden layers, which can each have respective nodes. That is, the visual model 105 can process input data through its layers to perform feature extraction, spatial reasoning, and/or scene understanding tasks. For example, the input layer processes raw image data. For example, the output layer generates semantic embeddings of scenes. For example, the intermediate layers extract features such as object boundaries, interactions, and context.

In some implementations, the visual model 105 can include a hierarchical architecture including an input processing layer, a feature transformation layer, and/or an output generation layer. Each layer can include a plurality of nodes or subcomponents configured to perform specific computations. That is, the visual model 105 can process input data by propagating it through the layers. For example, the input processing layer can preprocess frames by normalizing raw input data or extracting initial embeddings. For example, the feature transformation layer can enhance representations by applying non-linear transformations or performing dimensionality reduction using operations such as matrix multiplication and activation functions. For example, the output generation layer can output commands.

In some implementations, the system 100 can configure (e.g., train, update, fine tune, apply transfer learning to) the visual model 105 by modifying or updating one or more parameters, such as weights and/or biases, of various nodes of the visual model 105. The modification or update can be responsive to evaluating estimated outputs of the visual model 105 (e.g., generated in response to receiving training examples in a training dataset, such as a training dataset including labeled scene descriptions and corresponding avatar inputs). The visual system 104 can be or include various neural network models, including models that can operate on or generate data including but not limited to scene embeddings, detected object properties, predicted inputs, and/or various combinations thereof.

In some implementations, the visual system 104 can be configured (e.g., trained, updated, fine-tuned, has transfer learning performed, etc.) based at least on the training data of the at least one training dataset (e.g., frames, scene descriptions, input commands). For example, one or more example frames and/or associated avatar inputs of the training data can be applied (e.g., by the system 100, or in a pre-training process performed by the system 100 or another system) as input to the visual system 104 to cause the visual model 105 to generate an estimated output. The estimated output can be evaluated and/or compared with ground truth labels (or expected outcomes) of the training data that correspond with the one or more example frames and/or inputs, and the visual model 105 of the visual system 104 can be updated based at least on the error and/or feedback. For example, based at least on an output of predicted commands, one or more parameters (e.g., weights and/or biases) of visual model 105 can be updated.

In some implementations, the visual system 104 can apply at least one second VLM (e.g., visual model(s) 105, such as anomaly detection models, bug classification models, feature consistency models, and/or any specialized AI models) to cause the at least one second VLM to identify at least one visual anomaly (e.g., defect, bug, and/or any unexpected deviation) within the virtual environment of the application. That is, identifying the at least one visual anomaly can include the at least one second VLM detecting at least one inconsistency in at least one physics interaction, object behavior, or visual rendering during the game session. For example, an inconsistency in at least one physics interaction can be unexpected collisions, missing gravity effects, unresponsive surfaces, and/or any related anomaly. In another example, an inconsistency in an object behavior can be non-functional animations, invalid state transitions, missing interactions, and/or any unexpected movement. In yet another example, an inconsistency in a visual rendering during the game session can be graphical glitches, missing textures, incorrect lighting, and/or any unexpected rendering defect.

In some implementations, the second VLM can be structurally different from the first VLM configured to generate scene descriptions. That is, a first visual model 105 can be implemented to perform scene understanding and a second visual model 105 can be implemented to perform anomaly detection. Additionally, the visual system 104 can associate the at least one visual anomaly with a corresponding input event of the plurality of input events. For example, the visual system 104 can store the detected anomaly in a structured log for debugging. In another example, the visual system 104 can cross-reference the anomaly with historical scene data to identify potential causes. In some implementations, a log of a plurality of input commands performed by the avatar during the game session can include the at least one visual anomaly.

In some implementations, the at least one command can be to update the state (e.g., movement of an object, triggering of an event, modification of an environmental condition, and/or initiation of an interaction) within the application. That is, the command can be an instruction to modify conditions or elements in the application environment. For example, updating the state can include changing the position of an avatar within the virtual environment. In this example, the command can be to move the avatar forward or navigate around an obstacle. In another example, updating the state can include altering properties of an object (e.g., allowing access to a previously locked area). In this example, the command can be to interact with the object or trigger the event.

In some implementations, the embedding stage can be the stage in the vision pipeline in which the system 100 can analyze scene descriptions to retrieve contextual data for input generation. The system 100 can include at least one embedding system 106. The embedding system 106 can retrieve and/or obtain a set of embeddings based at least on a similarity metric between the generated at least one scene description and the set of embeddings. The set of embeddings can include at least one corresponding input command of the avatar. That is, the embedding system 106 can obtain similar scene descriptions based at least in part on a similarity metric. The similarity metric can be a cosine similarity, Euclidean distance, dot product, Hamming distance, and/or any distance measure used for embedding comparison. In some implementations, the similarity metric can be determined by applying mathematical operations to compare vector representations of the current scene description and stored embeddings. That is, the embedding system 106 can use the similarity metric to compare the current scene description with stored embeddings to determine similar and/or relevant embeddings for contextual input generation. For example, the embedding system 106 can retrieve and/or obtain embeddings for previously encountered scenes with similar visual and contextual features to the current scene.

In some implementations, the embedding system 106 can perform retrieval by comparing the vector representation of the current scene description against stored embeddings in a vector database. The embeddings stored in the vector database can represent previously processed scene descriptions and corresponding input commands. At least one (e.g., each) embedding can encode visual and contextual features, such as detected objects, spatial relationships, and environmental attributes, in a vector space. Using the similarity metric and a retrieval-augmented generation (RAG) framework, the embedding system 106 can identify stored embeddings that are most similar (e.g., closely aligned in vector direction, geometrically proximate, or semantically related) to the current scene description. For example, the embedding system 106 can calculate the cosine similarity between the current scene vector and at least one (e.g., each) stored embedding to rank the embeddings by relevance. The embedding with the highest similarity score can be retrieved and incorporated into the RAG framework to augment input commands for the current scene (e.g., by the language model(s) 109).

In some implementations, the similarity metric can quantify how closely (e.g., the current vector representation of aligns with a stored vector representation based at least in part on shared visual attributes, object distributions, and/or contextual relationships) the current scene description matches stored embeddings by analyzing the geometric relationship between vectors in the space (e.g., angular distance, spatial proximity, or magnitude correlation). For example, a cosine similarity score approaching 1 indicates that the vectors are closely aligned, representing similar scenes. In another example, the Euclidean distance can be used to calculate the shortest path between two vectors, where smaller distances represent greater similarity. The embedding system 106 can use the similarity metrics to filter and retrieve relevant embeddings without processing the entire dataset. In some implementations, additional metrics can be applied to capture specific aspects of scene similarity. The retrieved embeddings can be integrated into a retrieval-augmented generation (RAG) process to provide contextual data for adaptive input generation (e.g., generate input commands by language model(s) 109).

In some implementations, retrieving the set of embeddings can include the embedding system 106 identifying at least one vector (e.g., representation of scene attributes) of the plurality of vectors corresponding to at least one stored scene description of the plurality of scene descriptions. During gameplay, embedding system 106 can identify vectors (e.g., embeddings) that correspond to similar scene descriptions (e.g., scenes with matching or closely related visual and contextual features). That is, the embedding system 106 can compare the vector representation of the current scene to stored vectors using a similarity metric to retrieve embeddings that closely match the current scene. For example, the embedding system 106 can calculate the cosine similarity score to rank stored vectors and retrieve and/or otherwise obtain the one with the highest relevance to the current scene. Additionally, the at least one vector can include the corresponding avatar inputs of the at least one stored scene description. That is, the retrieved vector can contain associated input commands that were successfully applied in the past for similar scenes. For example, the vector can provide commands such as moving forward, turning left, or interacting with objects that align with the context of the current scene.

In some implementations, retrieving the set of embeddings can include using retrieval-augmented generation (RAG). That is, the embedding system 106 can retrieve embeddings from the vector database and provide them as context to language model(s) 109 of the command system 108, which can use the retrieved embeddings to generate at least one input command for the avatar. For example, the embedding system 106 can retrieve scene descriptions and associated input commands, and the command system 108 can integrate this contextual data with real-time scene analysis to predict adaptive input commands using RAG. Additionally, the at least one input command can be agnostic to the application or a game engine executing the application. That is, the input commands generated by the command system 108 can function independently of the underlying game engine or application architecture, allowing for applicability across different platforms. For example, the input commands can include movement or interaction actions derived from scene context without requiring integration with game-specific APIs. In another example, the input commands can be generated based at least in part on retrieved contextual embeddings and real-time scene data, allowing flexibility across diverse virtual environments.

In some implementations, the capture device 102, visual system 104 (e.g., using the visual model 105), and/or embedding system 106 can prepare a knowledge base of scene descriptions and corresponding input commands. That is, the capture device 102, visual system 104, and/or embedding system 106 can facilitate the creation of a structured repository of contextual embeddings derived from gameplay data. The capture device 102 can identify application data (e.g., frame sequences, rendering metadata, and player interactions) of an application (e.g., a game, simulation, or virtual training system). For example, the capture device 102 can capture frames rendered during gameplay, annotate the frames with timestamps, and associate them with user input events. The capture device 102 can map a plurality of frames of the application data to a plurality of avatar inputs (e.g., ground truth corresponding to keyboard input, mouse inputs, controller inputs, and/or any movement or interaction actions of an avatar and/or any associated events). For example, the capture device 102 can log one or more inputs such as “move forward,” “turn left,” or “interact with object” alongside the corresponding frames.

In some implementations, the visual system 104 can generate, using a visual model 105, a plurality of scene descriptions corresponding to the plurality of frames. For example, the visual system 104 can process each frame to extract visual features, identify objects, and generate textual descriptions capturing the spatial and contextual relationships within the scene. Additionally, the embedding system 106 can generate a set of embeddings (e.g., vector representations of scene descriptions, contextual features, and associated inputs) including a plurality of vectors. That is, the plurality of vectors can include the plurality of scene descriptions and corresponding avatar inputs of the plurality of avatar inputs. For example, the embedding system 106 can encode scene descriptions and inputs into high-dimensional vectors optimized for similarity-based retrieval. In some implementations, the generated set of embeddings can be stored by the embedding system 106 in a vector database (e.g., a key-value store, a distributed database, and/or any data source configured to support similarity search and retrieval). For example, the embedding system 106 can index embeddings in a vector database to facilitate retrieval based at least in part on similarity metrics during gameplay, game testing, and/or to facilitate adaptive input generation by providing context-aware commands derived from stored scene descriptions and associated inputs.

In some implementations, the command modeling stage can be the stage in the vision pipeline in which the system 100 can generate input commands for an avatar based at least in part on retrieved embeddings and scene context. The system 100 can include at least one command system 108. The command system 108 can include language model(s) 109. The command system 108 can apply the set of embeddings (e.g., vector representations of scene descriptions and corresponding avatar inputs) including the at least one corresponding input command (e.g., prior actions associated with similar scenes) to at least one language model, such as a large language model (LLM), (e.g., language model(s) 109) to cause the at least one LLM to generate at least one input command of the avatar corresponding with updating a position or action of the avatar in the application. That is, the command system 108 can apply the set of embeddings by providing them as context for input command prediction. The input commands can be used to cause a state update in the application. For example, the command system 108 can process the retrieved embeddings and determine the at least one contextual input. That is, the language model 109 can be caused to generate the input command (e.g., move forward, turn left, interact with an object, and/or perform a navigation or action command, where the state can be a current configuration of environmental features and/or avatar attributes) based at least on the similarity between the current scene and retrieved embeddings. For example, the command system 108 can predict adaptive inputs to navigate obstacles or engage with interactive elements. In this example, the state can be a position of the avatar within the environment and surrounding obstacles and can be updated to be a new position and/or a resolved interaction with an object. The input command can be generated according to the contextual information encoded in the embeddings.

Additionally, updating a position or action can include performing a movement and/or sequence of movements of the avatar in the simulation and/or executing context-aware interactions with at least one object in the environment. That is, the command system 108 can determine commands that align with the current scene context and prior actions stored in the embeddings. In some implementations, updating the position or action of the avatar can include avoiding a visual obstacle, interacting with non-playable characters, triggering in-game mechanisms, and/or any action based at least in part on the environment (e.g., dynamic or static features) of the application. For example, the movement of the avatar can be to avoid an abstract (e.g., physical barriers, environmental hazards, enemy characters, and/or any navigational challenge) detected in the game environment. In another example, updating a position can include recalibrating the direction of the avatar to align with a navigation path. In yet another example, updating an action can include interacting with a detected object or triggering a game mechanism. In some implementations, the input command can be performed by the interface system 110. In some implementations, the set of embeddings can be agnostic to the current scene (e.g., based at least in part on prior scenarios without direct dependency on the real-time frame) such that the LLM can predict and/or otherwise estimate a command or set of commands for a player based at least in part on prior used actions in similar scenarios.

In some implementations, the command system 108 can generate, using at least one neural network (e.g., a transformer-based model, recurrent neural network, convolutional neural network), a quality score of the position or action of the avatar. The quality score can be a quantitative measure of how effective or accurate the predicted input command is based at least in part on the current context. That is, the command system 108 can assess the output of the language model(s) 109 by analyzing the alignment between predicted commands and stored embeddings or contextual data. For example, the command system 108 can apply the predicted input command and the scene description to a neural network to cause the neural network to generate a confidence score (e.g., quantitative measure of the predicted alignment of the command with the scene context, such as a probability of successful execution, similarity to prior successful actions, expected navigation accuracy). In some implementations, the at least one input command is performed responsive to the quality score satisfying a predetermined threshold (e.g., meeting a minimum confidence level, surpassing a contextual similarity score, or aligning with expected performance metrics). That is, the interface system 110 can perform the command responsive to the quality score meeting or exceeding the threshold. For example, the interface system 110 can execute the command in the application to update the position or action of the avatar if and/or when the quality score indicates a high likelihood of successful execution.

The command system 108 can include any one or more artificial intelligence models (e.g., machine learning models, supervised models, neural network models, deep neural network models), rules, heuristics, algorithms, functions, or various combinations thereof to perform operations including generating input commands, such as updating the position or action of an avatar in a virtual environment. That is, language model 109 can be a neural network and/or machine-learning (ML) model trained to analyze scene descriptions and contextual embeddings to predict adaptive input commands. In some implementations, the command system 108 can output predicted input commands (e.g., move forward, turn left, interact with an object, and/or any context-aware avatar action). For example, the output can be a sequence of actions to navigate obstacles. In another example, the output can be a single command to interact with a detected object. In some implementations, the retrieved embeddings can be provided to command system 108 to perform command generation based at least in part on prior contextual data.

In some implementations, the command system 108 can maintain, execute, train, update, and/or otherwise process, refile, or apply one or more artificial intelligence (AI) models during the command modeling stage. In some implementations, the AI model(s) can include any type of transformer-based AI model capable of processing scene descriptions and embeddings (e.g., VLM outputs, contextual embeddings) to generate adaptive commands. For example, the AI model(s) can be trained and/or updated to predict navigation actions, object interactions, among other tasks. The AI model(s) can be or include a transformer-based model (e.g., a generative pre-trained transformer (GPT) model, a bidirectional encoder representations from transformers (BERT)). The machine-learning model(s) can be or include a recurrent neural network (RNN) model, in some implementations. The command system 108 can execute the AI model to generate outputs. The command system 108 can receive data to provide as input to the AI model(s), which can include embeddings, scene descriptions, avatar inputs, and/or any prior contextual data.

In some implementations, the command system 108 can execute one or more AI models (e.g., language model(s) 109) by utilizing a retrieval-augmented generation (RAG) framework of embedding system 106 to improve the performance of the AI model during the command modeling stage. The framework can include implementing techniques such as gradient descent, backpropagation, and distributed training to process large-scale datasets. The AI model(s) can incorporate mechanisms such as regularization and weight pruning to maintain efficiency and prevent overfitting. For example, during execution, the command system 108 can partition input data into mini-batches, apply loss functions, and update model parameters iteratively. The AI models can support inference operations that include processing feature vectors, transforming raw input data, and generating probabilistic predictions and/or metrics. The command system 108 can integrate hardware accelerators such as GPUs or TPUs to meet computational demands. In some implementations, the command system 108 can evaluate trained models using benchmark metrics (e.g., precision, recall, and/or F1 score) and/or any performance indicators, to determine readiness for deployment and/or inference operations.

In some implementations, the command system 108 can include at least one AI model (e.g., language model(s) 109). The language model 109 can include an input layer, an output layer, and/or one or more intermediate layers, such as hidden layers, which can each have respective nodes. That is, the language model 109 can process input embeddings and scene descriptions to generate input commands. For example, the input layer can receive embeddings representing contextual scene data. For example, the output layer can output predicted input commands for the avatar. For example, the intermediate layers can process features such as object relationships, spatial attributes, and/or contextual patterns.

In some implementations, the language model 109 can include a hierarchical architecture including an input processing layer, a feature transformation layer, and/or an output generation layer. Each layer can include a plurality of nodes or subcomponents configured to perform specific computations. That is, the language model 109 can process input data by propagating it through the layers. For example, the input processing layer can preprocess embeddings by normalizing raw input data or extracting initial contextual features. For example, the feature transformation layer can enhance representations by applying non-linear transformations or performing dimensionality reduction using operations such as matrix multiplication and activation functions. For example, the output generation layer can output predicted input commands by generating classification scores, regression outputs, and/or other inferential results based at least in part on the processed data.

In some implementations, the system 100 can configure (e.g., train, update, fine tune, apply transfer learning to) the language model 109 by modifying or updating one or more parameters, such as weights and/or biases, of various nodes of the language model 109 responsive to evaluating estimated outputs of the language model 109 (e.g., generated in response to receiving training examples in a training dataset, such as a training dataset including labeled scene descriptions, contextual embeddings, and/or associated avatar inputs). The command system 108 can be or include various neural network models, including models that can for operating on or generating data including but not limited to input commands, contextual embeddings, scene descriptions, and/or various combinations thereof.

In some implementations, the command system 108 can be configured (e.g., trained, updated, fine-tuned, has transfer learning performed, etc.) based at least on the training data of the at least one training dataset (e.g., embeddings, scene descriptions, associated input commands). For example, one or more example embeddings and/or input commands of the training data can be applied (e.g., by the system 100, or in a pre-training process performed by the system 100 or another system) as input to the command system 108 to cause the language model 109 to generate an estimated output. The estimated output can be evaluated and/or compared with ground truth labels (or expected outputs) of the training data that correspond with the one or more example embeddings and/or input commands, and the language model 109 of the command system 108 can be updated based at least on the error and/or feedback. For example, based at least on an output of predicted input commands, one or more parameters (e.g., weights and/or biases) of language model 109 of the command system 108 can be updated.

In some implementations, the interfacing stage can be the stage in the vision pipeline in which the system 100 can execute the generated input commands to interact with the application and update the position or action of the avatar (e.g., player, non-playable character (NPC), virtual agent, and/or any simulated entity). The system 100 can include at least one interface system 110. The interface system 110 can perform the at least one input command within the application to update the position or action of the avatar. Performing the command can include updating the state within the application. For example, the interface system 110 can apply the input command to move an avatar to a new position within the virtual environment. In another example, the interface system 110 can trigger an interaction with an object (e.g., opening a door and/or activating a mechanism). That is, the interface system 110 can execute and/or otherwise apply the command (e.g., to cause a state update, to modify environmental conditions, to trigger scripted events, and/or any other actions that affect the behavior or environment of the application). For example, the interface system 110 can execute a movement command (e.g., move forward, turn left) to navigate the avatar through the virtual environment. In another example, the interface system 110 can otherwise perform an interaction command (e.g., pick up an object) to modify the interaction of the avatar with objects in the environment. In yet another example, the interface system 110 can otherwise perform a navigation correction command (e.g., reverse direction, avoid obstacle) to ensure the avatar avoids visual or environmental obstructions.

In some implementations, the command can be performed by the interface system 110 using system-level or application-level input simulation. That is, interfacing by the interface system 110 can include mapping the generated command to system-level input events, such as keystrokes or mouse actions, and applying them within the application. Additionally, the interface system 110 can be communicably coupled and/or otherwise integrated with the application to facilitate input execution. The application and/or virtual environment can be interfaced with using APIs, input emulation tools, and/or any software or hardware interaction layer. For example, the interface system 110 can emulate a keyboard or controller input to execute the command. In another example, the interface system 110 can send a direct API call to the application to perform the specified action.

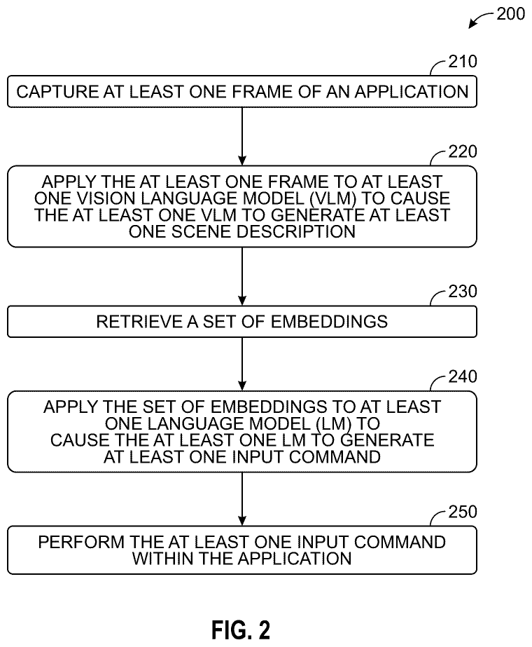

With reference to FIG. 2, an example flow diagram illustrating a method 200 for visual data processing and adaptative input generation in a vision pipeline, in accordance with some implementations of the present disclosure. It should be understood that this and other arrangements described herein are set forth only as examples. Other arrangements and elements (e.g., machines, interfaces, functions, orders, groupings of functions, etc.) can be used in addition to or instead of those shown, and some elements can be omitted altogether. Further, many of the elements described herein are functional entities that can be implemented as discrete or distributed components or in conjunction with other components, and in any combination and location. Various functions described herein as being performed by entities can be carried out by hardware, firmware, and/or software. For example, various functions can be carried out using one or more processor executing instructions stored in one or more memories. For example, in some implementations, the system and methods described herein can be implemented using one or more generative language models (e.g., as described in FIGS. 5A-5C), one or more computing devices or components thereof (e.g., as described in FIG. 6), and/or one or more data centers or components thereof (e.g., as described in FIG. 7).

Now referring to FIG. 2, each block of method 200, described herein, includes a computing process that can be performed using any combination of hardware, firmware, and/or software. For example, various functions can be carried out using one or more processors executing instructions stored in one or more memories. The method can also be embodied as computer-usable instructions stored on computer storage media. The method can be provided by a standalone application, a service or hosted service (standalone or in combination with another hosted service), as a microservice via an application programming interface (API) or a plug-in to another product, to name a few. In addition, method 200 is described, by way of example, with respect to the system of FIG. 1. However, this method can additionally or alternatively be executed by any one system, or any combination of systems, including, but not limited to, those described herein.

FIG. 2 is a flow diagram showing a method 200 for capturing, applying, retrieving, applying, and/or performing operations, in accordance with some implementations of the present disclosure. Various operations of method 200 can relate to improving the accuracy and adaptability of input generation in virtual and/or semi-virtual environments. Existing systems often rely on and/or use predefined scripts or surface-level image recognition tools, which can lead to limited adaptability and inefficiencies in dynamic or complex game scenes. The existing technological problems can arise when these systems encounter unpredictable obstacles or environmental changes, resulting in ineffective navigation or prolonged time stuck at obstacles. Method 200 of FIG. 2 can solve these technological problems by implementing a vision pipeline that integrates VLMs for scene understanding, RAG systems for retrieving embeddings representing prior scene descriptions and associated inputs, and LMs for generating adaptive input commands based at least in part on the current scene and retrieved embeddings, thereby facilitating dynamic navigation and interaction within virtual environments.

The method 200, at block 210, includes capturing at least one frame of an application corresponding with a viewpoint of an avatar in a virtual environment. That is, the processing circuits can capture and/or otherwise obtain a screenshot or snapshot of a current scene from a perspective of a player within a game. For example, the processing circuits can capture data from the rendering pipeline of the game engine to generate a frame representing the viewpoint of the avatar. In some implementations, the processing circuits can capture at least one frame of an application corresponding to an avatar in an environment. That is, instead of capturing the perspective of the player, the processing circuits can capture the entire scene or specific regions of interest, such as an overhead view or environmental interactions. In some implementations, the processing circuits can initiate execution of a capture script to record a plurality of input events and corresponding timestamps during a game session of the application. That is, the execution of the capture script can include the processing circuits capturing the at least one frame and a plurality of additional frames. For example, the processing circuits can implement and/or otherwise execute a script to capture the game scene during a game session. In some implementations, the processing circuits can record the plurality of input events and corresponding timestamps to generate a log of a plurality of input commands performed by the avatar during the game session. In some implementations, the processing circuits can continuously and/or periodically capture (e.g., in real-time or near real-time during gameplay and/or simulation) the plurality of additional frames during the game session. For example, the at least one frame can be captured responsive to receiving a start command in the application.

The method 200, at block 220, includes applying the at least one frame to at least one vision language model (VLM) to cause the at least one VLM to generate at least one scene description (e.g., textual descriptions of the scene) based at least in part on the at least one frame. In some implementations, generating the description can be based at least in part on at least one frame corresponding to a state (e.g., the position of an avatar, spatial relationships between objects, environmental conditions, detected interactions, dynamic changes in the scene, event triggers, and/or any contextual attributes of the virtual environment) within an application. For example, the processing circuits can process the frame through the VLM to extract contextual information, such as object locations, spatial relationships, and environmental details. In some implementations, the application generates the at least one frame of a rendering in the virtual environment. Additionally, the at least one scene description generated by the at least one VLM identifies at least one object or environmental feature within the virtual environment (e.g., scene description identifies objects or environmental elements in the game environment). In some implementations, the processing circuits can cause at least one first model to generate at least one scene description based at least in part on the at least one frame. In some implementations, the processing circuits can apply (e.g., during a game session) at least one second VLM to cause the at least one second VLM to identify at least one visual anomaly (e.g., defect or bug) within the virtual environment of the application. That is, identifying the at least one visual anomaly can include the at least one second VLM detecting at least one inconsistency in at least one physics interaction, object behavior, or visual rendering during the game session. In some implementations, the processing circuits can associate the at least one visual anomaly with a corresponding input event of the plurality of input events. For example, a log can include the at least one visual anomaly.

In some implementations, the processing circuits can perform and/or otherwise facilitate knowledge base preparation (e.g., using a vector database). The processing circuits can identify application data of the application and map a plurality of frames of the application data to a plurality of avatar inputs (e.g., ground truth data such as keyboard and mouse inputs). In some implementations, the processing circuits can generate, using the at least one VLM, a plurality of scene descriptions corresponding to the plurality of frames. In some implementations, the processing circuits can generate the set of embeddings including a plurality of vectors. That is, the plurality of vectors can include the plurality of scene descriptions and corresponding avatar inputs of the plurality of avatar inputs. Additionally, the processing circuits can store the set of embeddings in a vector database.

The method 200, at block 230, includes retrieving and/or otherwise obtaining a set of embeddings (e.g., similar scene descriptions with corresponding inputs) based at least on a similarity metric (e.g., cosine similarity, Euclidean distance, and/or dot product) between the generated at least one scene description and the set of embeddings (e.g., use the metric to compare the current scene description with stored embedding). That is, the set of embeddings can include at least one corresponding input command (or command) of the avatar. For example, the processing circuits can compare the generated scene description to stored embeddings to identify the most similar scenes (e.g., determined by cosine similarity, Euclidean distance, dot product, Hamming distance, and/or any vector similarity measure) and their associated input commands.

In some implementations, retrieving and/or obtaining the set of embeddings can include identifying at least one vector of the plurality of vectors corresponding to at least one stored scene description of the plurality of scene descriptions. For example, the at least one vector can include the corresponding avatar inputs of the at least one stored scene description. That is, during game play and/or simulation, the processing circuits can identify vectors (e.g., embeddings) that can correspond to a similar scene descriptions. In some implementations, retrieving the set of embeddings comprises using retrieval-augmented generation (RAG). That is, the processing circuits can use RAG to retrieve the embeddings. The at least one command (e.g., input command) can be agnostic to the application or a game engine executing the application. That is, the command can be agnostic across different game engines or applications (e.g., without requiring a specific integration). For example, the processing circuits can retrieve a command that generalizes across multiple applications using the stored embeddings.

The method 200, at block 240, includes applying the set of embeddings comprising the at least one corresponding input command to at least one language model, such as a large language model (LLM), to cause the at least one LM to generate at least one input command of the avatar corresponding with updating (e.g., movement or interaction of the avatar) a position or action of the avatar in the application. In some implementations, the input command can be to update the state within the application. That is, the processing circuits can use the LM that generates outputs that can be agnostic of the current scene. For example, the LM predicts a command for a player based at least in part on prior used actions in similar scenarios. Additionally, updating to the position or action of the avatar can include the processing circuits avoiding a visual obstacle within the virtual environment of the application. For example, the movement of the avatar can be to avoid an abstract detected in the game environment. In some implementations, the processing circuits can cause at least one second model to generate at least one input command of the avatar corresponding with updating a position or action of the avatar in the application based at least on the set of embeddings including the at least one corresponding input command. That is, the processing circuits can integrate retrieved embeddings with live scene data to generate an adaptive and contextually relevant input command. For example, the processing circuits can output a command to navigate around a detected obstacle or interact with a highlighted object.

The method 200, at block 250, includes performing the at least one input command within the application to update the position or action of the avatar. In some implementations, performing the input command can be to update a state within the application. That is, the processing circuits can apply the input command by simulating corresponding keyboard or mouse inputs within the application. For example, the command, such as moving or interacting with the game, can be performed by an interface system configured to emulate player inputs. Performing can be performed by mapping the generated command to hardware-level or API-level interactions within the application. In some implementations, the processing circuits can generate, using at least one neural network, a quality score of the position or action of the avatar. That is, the at least one input command can be performed responsive to the quality score satisfying a predetermined threshold (e.g., confidence above a certain level, matching contextual conditions, or aligning with historical actions).

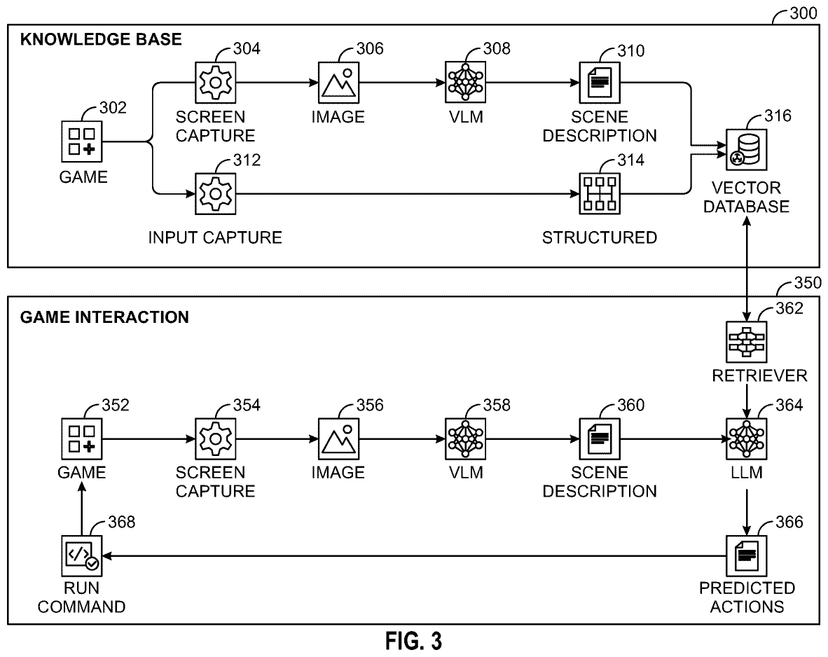

With reference to FIG. 3, a block diagram of an example training and command generation process, in accordance with some implementations of the present disclosure. The training and command generation process of FIG. 3 includes a knowledge base preparation pipeline 300 and a game interaction pipeline 350. In some implementations, the knowledge base preparation pipeline 300 begins with the system 100 of FIG. 1 capturing data from the game 302. The system 100 can capture screen data 304 representing frames of the virtual environment and input data 312 corresponding to user actions. The screen data 304 can be processed to generate images 306 (e.g., frame(s)). The images 306 can be applied to the vision language model (VLM) 308 (e.g., visual model(s) 105) to generate scene descriptions 310 representing the visual and contextual attributes of the captured frames. In some implementations, the system 100 structures input data 312 into structured data 314. The structured data 314 and scene descriptions 310 can be stored in a vector database 316 as embeddings for retrieval in the game interaction pipeline. That is, the vector database 316 can organize the stored embeddings to facilitate retrieval based at least in part on similarity metrics during gameplay. For example, embeddings representing prior scene descriptions and associated input commands can be retrieved (e.g., provided by the vector database 316) to provide context for adaptive input generation in the vision pipeline.

In some implementations, the game interaction pipeline 350 can begin with the system 100 capturing screen data 354 from the game 352 (e.g., by capture device 102). The screen data 354 can be processed to produce images 356 (e.g., frame(s)). The images 356 can be applied to the VLM 358 (e.g., visual model(s) 105) to generate scene descriptions 360 that describe the visual and contextual elements of the current game environment. The system 100 can use a retriever 362 (e.g., embedding system 106) to query the vector database 316 with the scene descriptions 360. The retriever 362 can retrieve embeddings that include previously stored scene descriptions and their corresponding input data (e.g., based at least in part on similarity metrics). The retrieved embeddings can be applied to a large language model (LLM) 364 (e.g., language model 109). The LLM 364 can generate predicted actions 366 corresponding to the position or actions of the avatar based at least in part on the current scene context.

In some implementations, the system 100 executes the predicted actions 366 using the run command 368 (e.g., by interface system 110) to update the position or action of the avatar within the game 352. For example, the predicted actions 366 can include commands to move, interact with objects, or avoid obstacles based at least in part on the current scene and retrieved embeddings. The vector database 316 can be used to facilitate continuity between the knowledge base preparation pipeline 300 and the game interaction pipeline 350 by storing and retrieving embeddings. The VLM 308 in the knowledge base pipeline 300 and the VLM 358 in the game interaction pipeline 350 can generate scene descriptions 310 and 360, respectively, to facilitate consistent processing across both pipelines.

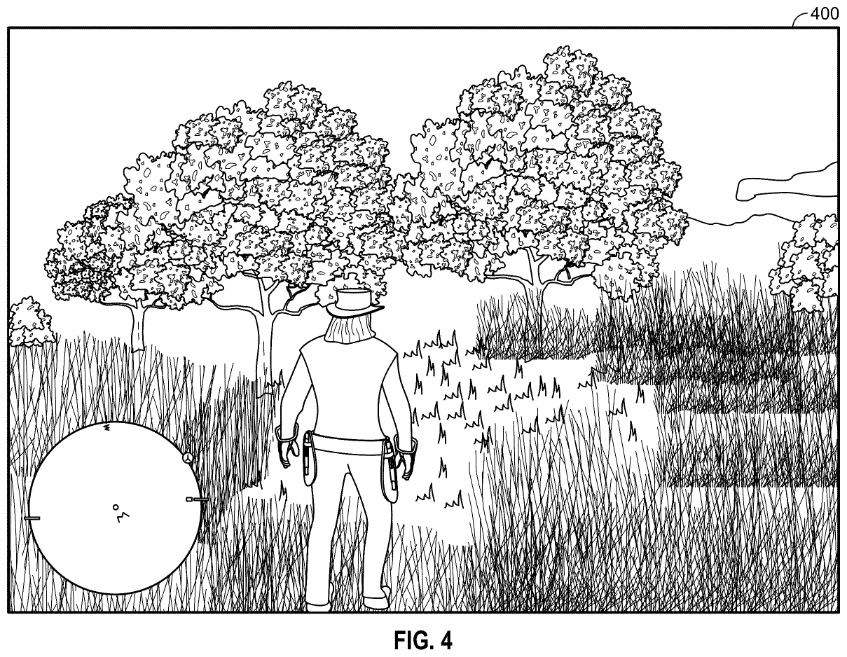

With reference to FIG. 4, an example illustration of a virtual environment 400, in accordance with some implementations of the present disclosure. The virtual environment 400 depicts a game scene including an avatar, environmental features such as trees, grass, and terrain, and a minimap interface located in the lower-left corner of the display. In some implementations, the capture device 102 of FIG. 1 can capture a frame of the virtual environment 400 as screen data for processing in the vision pipeline. For example, the capture device 102 can extract visual data from the game environment and pass it as input to the visual system 104.

In some implementations, the visual system 104, including the visual model 105 of FIG. 1, can process the captured frame to generate a scene description. For example, the visual model 105 can identify objects such as trees and terrain, contextual elements like spatial relationships, and dynamic attributes such as the position of the avatar relative to the environment. The embedding system 106 can retrieve relevant embeddings from a vector database by comparing the generated scene description with previously stored embeddings using a similarity metric. The embeddings can include scene descriptions and associated avatar inputs that correspond to prior game contexts similar to the current frame.

The command system 108, including the language model 109 of FIG. 1, can analyze the retrieved embeddings and the scene description generated by the visual model 105 to predict input commands for the avatar. For example, the language model 109 can generate a command for navigating the avatar around the trees, interacting with an object in the scene, or moving in a direction indicated by the minimap. The predicted input commands are passed to the interface system 110 for execution. In some implementations, the interface system 110 of FIG. 1 executes the predicted input commands within the virtual environment 400 by simulating input actions. For example, the interface system 110 can issue keystrokes or controller inputs to update the position or trigger interactions of the avatar based at least in part on the commands generated by the command system 108.

### Example Language Models

In at least some implementations, language models, such as large language models (LLMs), small language models (SLMs), vision language models (VLMs), multi-modal language models (MMLMs), and/or other types of generative artificial intelligence (AI) can be implemented. Generally, the language models can process input data, such as textual descriptions, visual data, or structured embeddings, to generate outputs including predictions, classifications, or contextually relevant commands for a plurality of applications. These models can be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based at least in part on the context provided in input prompts or queries. These language models can be considered “large,” in implementations, based at least in part on the models being trained on massive datasets and having architectures with large number of learnable network parameters (weights and biases)—such as millions or billions of parameters. The LLMs/SLMs/VLMs/MMLMs/etc. can be implemented for summarizing textual data, analyzing and extracting insights from data (e.g., textual, image, video, etc.), and generating new text/image/video/etc. in user-specified styles, tones, and/or formats. The LLMs/SLMs/VLMs/MMLMs/etc. of the present disclosure can be used exclusively for text processing, in implementations, whereas in other implementations, multi-modal LLMs can be implemented to accept, understand, and/or generate text and/or other types of content like images, audio, 2D and/or 3D data (e.g., in USD formats), and/or video. For example, vision language models (VLMs), or more generally multi-modal language models (MMLMs), can be implemented to accept image, video, audio, textual, 3D design (e.g., CAD), and/or other inputs data types and/or to generate or output image, video, audio, textual, 3D design, and/or other output data types.

Various types of LLMs/SLMs/VLMs/MMLMs/etc. architectures can be implemented in various implementations. For example, different architectures can be implemented that use different techniques for understanding and generating outputs—such as text, audio, video, image, 2D and/or 3D design or asset data, etc. In some implementations, LLMs/SLMs/VLMs/MMLMs/etc. architectures such as recurrent neural networks (RNNs) or long short-term memory networks (LSTMs) can be used, while in other implementations transformer architectures—such as those that rely on self-attention and/or cross-attention (e.g., between contextual data and textual data) mechanisms—can be used to understand and recognize relationships between words or tokens and/or contextual data (e.g., other text, video, image, design data, USD, etc.). One or more generative processing pipelines that include LLMs/SLMs/VLMs/MMLMs/etc. can also include one or more diffusion block(s) (e.g., denoisers). The LLMs/SLMs/VLMs/MMLMs/etc. of the present disclosure can include encoder and/or decoder block(s). For example, discriminative or encoder-only models like BERT (Bidirectional Encoder Representations from Transformers) can be implemented for tasks that involve language comprehension such as classification, sentiment analysis, question answering, and named entity recognition. As another example, generative or decoder-only models like GPT (Generative Pretrained Transformer) can be implemented for tasks that involve language and content generation such as text completion, story generation, and dialogue generation. LLMs/SLMs/VLMs/MMLMs/etc. that include both encoder and decoder components like T5 (Text-to-Text Transformer) can be implemented to understand and generate content, such as for translation and summarization. These examples are not intended to be limiting, and any architecture type—including but not limited to those described herein—can be implemented depending on the particular implementation and the task(s) being performed using the LLMs/SLMs/VLMs/MMLMs/etc.

In various implementations, the LLMs/SLMs/VLMs/MMLMs/etc. can be trained using unsupervised learning, in which an LLMs/SLMs/VLMs/MMLMs/etc. learns patterns from large amounts of unlabeled text/audio/video/image/design/USD/etc. data. Due to the extensive training, in implementations, the models cannot require task-specific or domain-specific training. LLMs/SLMs/VLMs/MMLMs/etc. that have undergone extensive pre-training on vast amounts of unlabeled data can be referred to as foundation models and can be adept at a variety of tasks like question-answering, summarization, filling in missing information, translation, image/video/design/USD/data generation. Some LLMs/SLMs/VLMs/MMLMs/etc. can be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some implementations, the LLMs/SLMs/VLMs/MMLMs/etc. of the present disclosure can be implemented using various model alignment techniques. For example, in some implementations, guardrails can be implemented to identify improper or undesired inputs (e.g., prompts) and/or outputs of the models. In doing so, the system can use the guardrails and/or other model alignment techniques to either prevent a particular undesired input from being processed using the LLMs/SLMs/VLMs/MMLMs/etc., and/or preventing the output or presentation (e.g., display, audio output, etc.) of information generating using the LLMs/SLMs/VLMs/MMLMs/etc. In some implementations, one or more additional models—or layers thereof—can be implemented to identify issues with inputs and/or outputs of the models. For example, these “safeguard” models can be trained to identify inputs and/or outputs that are “safe” or otherwise okay or desired and/or that are “unsafe” or are otherwise undesired for the particular application/implementation. As a result, the LLMs/SLMs/VLMs/MMLMs/etc. of the present disclosure can be less likely to output language/text/audio/video/design data/USD data/etc. that can be offensive, vulgar, improper, unsafe, out of domain, and/or otherwise undesired for the particular application/implementation.

In some implementations, the LLMs/SLMs/VLMs/etc. can be configured to or capable of accessing or using one or more plug-ins, application programming interfaces (APIs), databases, data stores, repositories, etc. For example, for certain tasks or operations that the model is not ideally suited for, the model can have instructions (e.g., as a result of training, and/or based at least in part on instructions in a given prompt) to access one or more plug-ins (e.g., 3^{rd} party plugins) for help in processing the current input. In such an example, where at least part of a prompt is related to restaurants or weather, the model can access one or more restaurant or weather plug-ins (e.g., via one or more APIs) to retrieve the relevant information. As another example, where at least part of a response requires a mathematical computation, the model can access one or more math plug-ins or APIs for help in solving the problem(s), and can then use the response from the plug-in and/or API in the output from the model. This process can be repeated—e.g., recursively—for any number of iterations and using any number of plug-ins and/or APIs until a response to the input prompt can be generated that addresses each ask/question/request/process/operation/etc. As such, the model(s) can not only rely on its own knowledge from training on a large dataset(s), but also on the expertise or optimized nature of one or more external resources—such as APIs, plug-ins, and/or the like.

In some implementations, multiple language models (e.g., LLMs/SLMs/VLMs/MMLMs/etc., multiple instances of the same language model, and/or multiple prompts provided to the same language model or instance of the same language model can be implemented, executed, or accessed (e.g., using one or more plug-ins, user interfaces, APIs, databases, data stores, repositories, etc.) to provide output responsive to the same query, or responsive to separate portions of a query. In at least one implementation, multiple language models e.g., language models with different architectures, language models trained on different (e.g. updated) corpuses of data can be provided with the same input query and prompt (e.g., set of constraints, conditioners, etc.). In one or more implementations, the language models can be different versions of the same foundation model. In one or more implementations, at least one language model can be instantiated as multiple agents—e.g., more than one prompt can be provided to constrain, direct, or otherwise influence a style, a content, or a character, etc., of the output provided. In one or more example, non-limiting implementations, the same language model can be asked to provide output corresponding to a different role, perspective, character, or having a different base of knowledge, etc.—as defined by a supplied prompt.

In any one of such implementations, the output of two or more (e.g., each) language models, two or more versions of at least one language model, two or more instanced agents of at least one language model, and/or two more prompts provided to at least one language model can be further processed, e.g., aggregated, compared or filtered against, or used to determine (and provide) a consensus response. In one or more implementations, the output from one language model—or version, instance, or agent—can be provided as input to another language model for further processing and/or validation. In one or more implementations, a language model can be asked to generate or otherwise obtain an output with respect to an input source material, with the output being associated with the input source material. Such an association can include, for example, the generation of a caption or portion of text that is embedded (e.g., as metadata) with an input source text or image. In one or more implementations, an output of a language model can be used to determine the validity of an input source material for further processing, or inclusion in a dataset. For example, a language model can be used to assess the presence (or absence) of a target word in a portion of text or an object in an image, with the text or image being annotated to note such presence (or lack thereof). Alternatively, the determination from the language model can be used to determine whether the source material should be included in a curated dataset, for example and without limitation.

FIG. 5A is a block diagram of an example generative language model system 500 suitable for use in implementing at least some implementations of the present disclosure. Generally, the example generative language model system 500 can process scene descriptions and retrieved embeddings to generate context-aware input commands for controlling an avatar within a virtual environment. In the example illustrated in FIG. 5A, the generative language model system 500 includes a retrieval augmented generation (RAG) component 592, an input processor 505, a tokenizer 510, an embedding component 520, plug-ins/APIs 595, and a generative language model (LM) 530 (which can include an LLM, a SLM, a VLM, a multi-modal LM, etc.).

At a high level, the input processor 505 can receive an input 501 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 530 (e.g., LLMs/SLMs/VLMs/MMLMs/etc.). In some implementations, the input 501 includes plain text in the form of one or more sentences, paragraphs, and/or documents. Additionally or alternatively, the input 501 can include numerical sequences, precomputed embeddings (e.g., word or sentence embeddings), and/or structured data (e.g., in tabular formats, JSON, or XML). In some implementations in which the generative LM 530 is capable of processing multi-modal inputs, the input 501 can combine text (or can omit text) with image data, audio data, video data, design data, USD data, and/or other types of input data, such as but not limited to those described herein. Taking raw input text as an example, the input processor 505 can prepare raw input text in various ways. For example, the input processor 505 can perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 505 can remove stopwords to reduce noise and focus the generative LM 530 on more meaningful content. The input processor 505 can apply text normalization, for example, by converting all characters to lowercase, removing accents, and/or or handling special cases like contractions or abbreviations to ensure consistency. These are just a few examples, and other types of input processing can be applied.

In some implementations, a RAG component 592 (which can include one or more RAG models, and/or can be performed using the generative LM 530 itself) can be used to retrieve additional information to be used as part of the input 501 or prompt. RAG can be used to enhance the input to the LLMs/SLMs/VLMs/MMLMs/etc. with external knowledge, so that answers to specific questions or queries or requests are more relevant—such as in a case where specific knowledge is required. The RAG component 592 can fetch this additional information (e.g., grounding information, such as grounding text/image/video/audio/USD/CAD/etc.) from one or more external sources, which can then be fed to the LLMs/SLMs/VLMs/MMLMs/etc. along with the prompt to improve accuracy of the responses or outputs of the model.

For example, in some implementations, the input 501 can be generated using the query or input to the model (e.g., a question, a request, etc.) in addition to data retrieved using the RAG component 592. In some implementations, the input processor 505 can analyze the input 501 and communicate with the RAG component 592 (or the RAG component 592 can be part of the input processor 505, in implementations) in order to identify relevant text and/or other data to provide to the generative LM 530 as additional context or sources of information from which to identify the response, answer, or output 590, generally. For example, where the input indicates that the user is interested in a desired tire pressure for a particular make and model of vehicle, the RAG component 592 can retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 592 can retrieve a prior stored conversation history—or at least a summary thereof—and include the prior conversation history along with the current ask/request as part of the input 501 to the generative LM 530.

The RAG component 592 can use various RAG techniques. For example, naïve RAG can be used where documents are indexed, chunked, and applied to an embedding model to generate embeddings corresponding to the chunks. A user query can also be applied to the embedding model and/or another embedding model of the RAG component 592 and the embeddings of the chunks along with the embeddings of the query can be compared to identify the most similar/related embeddings to the query, which can be supplied to the generative LM 530 to generate an output.

In some implementations, more advanced RAG techniques can be used. For example, prior to passing chunks to the embedding model, the chunks can undergo pre-retrieval processes (e.g., routing, rewriting, metadata analysis, expansion, etc.). In addition, prior to generating the final embeddings, post-retrieval processes (e.g., re-ranking, prompt compression, etc.) can be performed on the outputs of the embedding model prior to final embeddings being used as comparison to an input query.

As a further example, modular RAG techniques can be used, such as those that are similar to naïve and/or advanced RAG, but also include features such as hybrid search, recursive retrieval and query engines, StepBack approaches, sub-queries, and hypothetical document embedding.

As another example, Graph RAG can use knowledge graphs as a source of context or factual information. Graph RAG can be implemented using a graph database as a source of contextual information sent to the LLMs/SLMs/VLMs/MMLMs/etc. Rather than (or in addition to) providing the model with chunks of data extracted from larger sized documents—which can result in a lack of context, factual correctness, language accuracy, etc.—graph RAG can also provide structured entity information to the LLMs/SLMs/VLMs/MMLMs/etc. by combining the structured entity textual description with its many properties and relationships, allowing for deeper insights by the model. When implementing graph RAG, the systems and methods described herein use a graph as a content store and extract relevant chunks of documents and ask the LLMs/SLMs/VLMs/MMLMs/etc. to answer using them. The knowledge graph, in such implementations, can contain relevant textual content and metadata about the knowledge graph as well as be integrated with a vector database. In some implementations, the graph RAG can use a graph as a subject matter expert, where descriptions of concepts and entities relevant to a query/prompt can be extracted and passed to the model as semantic context. These descriptions can include relationships between the concepts. In other examples, the graph can be used as a database, where part of a query/prompt can be mapped to a graph query, the graph query can be executed, and the LLMs/SLMs/VLMs/MMLMs/etc. can summarize the results. In such an example, the graph can store relevant factual information, and a query (natural language query) to graph query tool (NL-to-Graph-query tool) and entity linking can be used. In some implementations, graph RAG (e.g., using a graph database) can be combined with standard (e.g., vector database) RAG, and/or other RAG types, to benefit from multiple approaches.

In any implementations, the RAG component 592 can implement a plugin, API, user interface, and/or other functionality to perform RAG. For example, a graph RAG plug-in can be used by the LLMs/SLMs/VLMs/MMLMs/etc. to run queries against the knowledge graph to extract relevant information for feeding to the model, and a standard or vector RAG plug-in can be used to run queries against a vector database. For example, the graph database can interact with a REST interface plug-in such that the graph database is decoupled from the vector database and/or the embeddings models.

The tokenizer 510 can segment the (e.g., processed) text data into smaller units (tokens) for subsequent analysis and processing. The tokens can represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 530 to understand morphological variations and handle out-of-vocabulary words more effectively. Character-based tokenization represents each character as a separate token, enabling the generative LM 530 to process text at a fine-grained level. The choice of tokenization strategy can depend on factors such as the language being processed, the task at hand, and/or characteristics of the training dataset. As such, the tokenizer 510 can convert the (e.g., processed) text into a structured format according to tokenization schema being implemented in the particular implementation.

The embedding component 520 can use any known embedding technique to transform discrete tokens into (e.g., dense, continuous vector) representations of semantic meaning. For example, the embedding component 520 can use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 501 includes image data/video data/etc., the input processor 505 can resize the data to a standard size compatible with format of a corresponding input channel and/or can normalize pixel values to a common range (e.g., 0 to 1) to ensure a consistent representation, and the embedding component 520 can encode the image data using any known technique (e.g., using one or more convolutional neural networks (CNNs) to extract visual features). In some implementations in which the input 501 includes audio data, the input processor 505 can resample an audio file to a consistent sampling rate for uniform processing, and the embedding component 520 can use any known technique to extract and encode audio features—such as in the form of a spectrogram (e.g., a mel-spectrogram). In some implementations in which the input 501 includes video data, the input processor 505 can extract frames or apply resizing to extracted frames, and the embedding component 520 can extract features such as optical flow embeddings or video embeddings and/or can encode temporal information or sequences of frames. In some implementations in which the input 501 includes multi-modal data, the embedding component 520 can fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 530 and/or other components of the generative LM system 500 can use different types of neural network architectures depending on the implementation. For example, transformer-based architectures such as those used in models like GPT can be implemented, and can include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 520 can apply an encoded representation of the input 501 to the generative LM 530, and the generative LM 530 can process the encoded representation of the input 501 to generate an output 590, which can include responsive text and/or other types of data.

As described herein, in some implementations, the generative LM 530 can be configured to access or use—or capable of accessing or using—plug-ins/APIs 595 (which can include one or more plug-ins, application programming interfaces (APIs), databases, data stores, repositories, etc.). For example, for certain tasks or operations that the generative LM 530 is not ideally suited for, the model can have instructions (e.g., as a result of training, and/or based at least in part on instructions in a given prompt, such as those retrieved using the RAG component 592) to access one or more plug-ins/APIs 595 (e.g., 3^{rd} party plugins) for help in processing the current input. In such an example, where at least part of a prompt is related to restaurants or weather, the model can access one or more restaurant or weather plug-ins (e.g., via one or more APIs), send at least a portion of the prompt related to the particular plug-in/API 595 to the plug-in/API 595, the plug-in/API 595 can process the information and return an answer to the generative LM 530, and the generative LM 530 can use the response to generate the output 590. This process can be repeated—e.g., recursively—for any number of iterations and using any number of plug-ins/APIs 595 until an output 590 that addresses each ask/question/request/process/operation/etc. from the input 501 can be generated. As such, the model(s) can not only rely on its own knowledge from training on a large dataset(s) and/or from data retrieved using the RAG component 592, but also on the expertise or optimized nature of one or more external resources—such as the plug-ins/APIs 595.

FIG. 5B is a block diagram of an example implementation in which the generative LM 530 includes a transformer encoder-decoder. Generally, the generative LM 530 can analyze embeddings representing stored scene descriptions and contextual data alongside current scene descriptions to generate input commands for updating a position or action of an avatar within a virtual environment. For example, assume input text such as “Who discovered gravity” is tokenized (e.g., by the tokenizer510 of FIG. 5A) into tokens such as words, and each token is encoded (e.g., by the embedding component 520 of FIG. 5A) into a corresponding embedding (e.g., of size 512). Since these token embeddings typically do not represent the position of the token in the input sequence, any known technique can be used to add a positional encoding to each token embedding to encode the sequential relationships and context of the tokens in the input sequence. As such, the (e.g., resulting) embeddings can be applied to one or more encoder(s) 535 of the generative LM 530.

In an example implementation, the encoder(s) 535 forms an encoder stack, where each encoder includes a self-attention layer and a feedforward network. In an example transformer architecture, each token (e.g., word) flows through a separate path. As such, each encoder can accept a sequence of vectors, passing each vector through the self-attention layer, then the feedforward network, and then upwards to the next encoder in the stack. Any known self-attention technique can be used. For example, to calculate a self-attention score for each token (word), a query vector, a key vector, and a value vector can be created for each token, a self-attention score can be calculated for pairs of tokens by taking the dot product of the query vector with the corresponding key vectors, normalizing the resulting scores, multiplying by corresponding value vectors, and summing weighted value vectors. The encoder can apply multi-headed attention in which the attention mechanism is applied multiple times in parallel with different learned weight matrices. Any number of encoders can be cascaded to generate a context vector encoding the input. An attention projection layer 540 can convert the context vector into attention vectors (keys and values) for the decoder(s) 545.

In an example implementation, the decoder(s) 545 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 535, in an example transformer architecture, each token (e.g., word) flows through a separate path in the decoder(s) 545. During a first pass, the decoder(s) 545, a classifier 550, and a generation mechanism 555 can generate a first token, and the generation mechanism 555 can apply the generated token as an input during a second pass. The process can repeat in a loop, successively generating and adding tokens (e.g., words) to the output from the preceding pass and applying the token embeddings of the composite sequence with positional encodings as an input to the decoder(s) 545 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 535, except that it creates its queries from the layer below it and takes the keys and values (e.g., matrix) from the output of the encoder(s) 535.

As such, the decoder(s) 545 can output some decoded (e.g., vector) representation of the input being applied during a particular pass. The classifier 550 can include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 555 can select or sample a word or token based at least in part on a corresponding predicted probability (e.g., select the word with the highest predicted probability) and append it to the output from a previous pass, generating each word or token sequentially. The generation mechanism 555 can repeat the process, triggering successive decoder inputs and corresponding predictions until selecting or sampling a symbol or token that represents the end of the response, at which point, the generation mechanism 555 can output the generated response.

FIG. 5C is a block diagram of an example implementation in which the generative LM 530 includes a decoder-only transformer architecture. For example, the decoder(s) 560 of FIG. 5C can operate similarly as the decoder(s) 545 of FIG. 5B except each of the decoder(s) 560 of FIG. 5C omits the encoder-decoder self-attention layer (since there is no encoder in this implementation). As such, the decoder(s) 560 can form a decoder stack, where each decoder includes a self-attention layer and a feedforward network. Furthermore, instead of encoding the input sequence, a symbol or token representing the end of the input sequence (or the beginning of the output sequence) can be appended to the input sequence, and the resulting sequence (e.g., corresponding embeddings with positional encodings) can be applied to the decoder(s) 560. As with the decoder(s) 545 of FIG. 5B, each token (e.g., word) can flow through a separate path in the decoder(s) 560, and the decoder(s) 560, a classifier 565, and a generation mechanism 570 can use auto-regression to sequentially generate one token at a time until predicting a symbol or token that represents the end of the response. The classifier 565 and the generation mechanism 570 can operate similarly as the classifier 550 and the generation mechanism 555 of FIG. 5B, with the generation mechanism 570 selecting or sampling each successive output token based at least in part on a corresponding predicted probability and appending it to the output from a previous pass, generating each token sequentially until selecting or sampling a symbol or token that represents the end of the response. These and other architectures described herein are meant simply as examples, and other suitable architectures can be implemented within the scope of the present disclosure.

### Example Computing Device

FIG. 6 is a block diagram of an example computing device(s) 600 suitable for use in implementing some implementations of the present disclosure. Generally, the example computing device(s) 600 can execute the components of the vision pipeline, including the capture device, visual system, embedding system, command system, and interface system, to process visual data, generate contextual embeddings, predict input commands, and perform avatar actions within a virtual environment. Computing device 600 can include an interconnect system 602 that directly or indirectly couples the following devices: memory 604, one or more central processing units (CPUs) 606, one or more graphics processing units (GPUs) 608, a communication interface 610, input/output (I/O) ports 612, input/output components 614, a power supply 616, one or more presentation components 618 (e.g., display(s)), and one or more logic units 620. In at least one implementation, the computing device(s) 600 can comprise one or more virtual machines (VMs), and/or any of the components thereof can comprise virtual components (e.g., virtual hardware components). For non-limiting examples, one or more of the GPUs 608 can comprise one or more vGPUs, one or more of the CPUs 606 can comprise one or more vCPUs, and/or one or more of the logic units 620 can comprise one or more virtual logic units. As such, a computing device(s) 600 can include discrete components (e.g., a full GPU dedicated to the computing device 600), virtual components (e.g., a portion of a GPU dedicated to the computing device 600), or a combination thereof.

Although the various blocks of FIG. 6 are shown as connected via the interconnect system 602 with lines, this is not intended to be limiting and is for clarity only. For example, in some implementations, a presentation component 618, such as a display device, can be considered an I/O component 614 (e.g., if the display is a touch screen). As another example, the CPUs 606 and/or GPUs 608 can include memory (e.g., the memory 604 can be representative of a storage device in addition to the memory of the GPUs 608, the CPUs 606, and/or other components). As such, the computing device of FIG. 6 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 6.

The interconnect system 602 can represent one or more links or busses, such as an address bus, a data bus, a control bus, or a combination thereof. The interconnect system 602 can include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some implementations, there are direct connections between components. As an example, the CPU 606 can be directly connected to the memory 604. Further, the CPU 606 can be directly connected to the GPU 608. Where there is direct, or point-to-point connection between components, the interconnect system 602 can include a PCIe link to carry out the connection. In these examples, a PCI bus need not be included in the computing device 600.

The memory 604 can include any of a variety of computer-readable media. The computer-readable media can be any available media that can be accessed by the computing device 600. The computer-readable media can include both volatile and nonvolatile media, and removable and non-removable media. By way of example, and not limitation, the computer-readable media can comprise computer-storage media and communication media.

The computer-storage media can include both volatile and nonvolatile media and/or removable and non-removable media implemented in any method or technology for storage of information such as computer-readable instructions, data structures, program modules, and/or other data types. For example, the memory 604 can store computer-readable instructions (e.g., that represent a program(s) and/or a program element(s), such as an operating system. Computer-storage media can include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 600. As used herein, computer storage media does not comprise signals per se.

The computer storage media can embody computer-readable instructions, data structures, program modules, and/or other data types in a modulated data signal such as a carrier wave or other transport mechanism and includes any information delivery media. The term “modulated data signal” can refer to a signal that has one or more of its characteristics set or changed in such a manner as to encode information in the signal. By way of example, and not limitation, the computer storage media can include wired media such as a wired network or direct-wired connection, and wireless media such as acoustic, RF, infrared and other wireless media. Combinations of any of the above should also be included within the scope of computer-readable media.

The CPU(s) 606 can be configured to execute at least some of the computer-readable instructions to control one or more components of the computing device 600 to perform one or more of the methods and/or processes described herein. The CPU(s) 606 can each include one or more cores (e.g., one, two, four, eight, twenty-eight, seventy-two, etc.) that are capable of handling a multitude of software threads simultaneously. The CPU(s) 606 can include any type of processor, and can include different types of processors depending on the type of computing device 600 implemented (e.g., processors with fewer cores for mobile devices and processors with more cores for servers). For example, depending on the type of computing device 600, the processor can be an Advanced RISC Machines (ARM) processor implemented using Reduced Instruction Set Computing (RISC) or an x86 processor implemented using Complex Instruction Set Computing (CISC). The computing device 600 can include one or more CPUs 606 in addition to one or more microprocessors or supplementary co-processors, such as math co-processors.

In addition to or alternatively from the CPU(s) 606, the GPU(s) 608 can be configured to execute at least some of the computer-readable instructions to control one or more components of the computing device 600 to perform one or more of the methods and/or processes described herein. One or more of the GPU(s) 608 can be an integrated GPU (e.g., with one or more of the CPU(s) 606 and/or one or more of the GPU(s) 608 can be a discrete GPU. In implementations, one or more of the GPU(s) 608 can be a coprocessor of one or more of the CPU(s) 606. The GPU(s) 608 can be used by the computing device 600 to render graphics (e.g., 3D graphics) or perform general purpose computations. For example, the GPU(s) 608 can be used for General-Purpose computing on GPUs (GPGPU). The GPU(s) 608 can include hundreds or thousands of cores that are capable of handling hundreds or thousands of software threads simultaneously. The GPU(s) 608 can generate pixel data for output images in response to rendering commands (e.g., rendering commands from the CPU(s) 606 received via a host interface). The GPU(s) 608 can include graphics memory, such as display memory, for storing pixel data or any other suitable data, such as GPGPU data. The display memory can be included as part of the memory 604. The GPU(s) 608 can include two or more GPUs operating in parallel (e.g., via a link). The link can directly connect the GPUs (e.g., using NVLINK) or can connect the GPUs through a switch (e.g., using NVSwitch). When combined together, each GPU 608 can generate pixel data or GPGPU data for different portions of an output or for different outputs (e.g., a first GPU for a first image and a second GPU for a second image). Each GPU can include its own memory, or can share memory with other GPUs.

In addition to or alternatively from the CPU(s) 606 and/or the GPU(s) 608, the logic unit(s) 620 can be configured to execute at least some of the computer-readable instructions to control one or more components of the computing device 600 to perform one or more of the methods and/or processes described herein. In implementations, the CPU(s) 606, the GPU(s) 608, and/or the logic unit(s) 620 can discretely or jointly perform any combination of the methods, processes and/or portions thereof. One or more of the logic units 620 can be part of and/or integrated in one or more of the CPU(s) 606 and/or the GPU(s) 608 and/or one or more of the logic units 620 can be discrete components or otherwise external to the CPU(s) 606 and/or the GPU(s) 608. In implementations, one or more of the logic units 620 can be a coprocessor of one or more of the CPU(s) 606 and/or one or more of the GPU(s) 608.

Examples of the logic unit(s) 620 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which can include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 610 can include one or more receivers, transmitters, and/or transceivers that allow the computing device 600 to communicate with other computing devices via an electronic communication network, included wired and/or wireless communications. The communication interface 610 can include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more implementations, logic unit(s) 620 and/or communication interface 610 can include one or more data processing units (DPUs) to transmit data received over a network and/or through interconnect system 602 directly to (e.g., a memory of) one or more GPU(s) 608.

The I/O ports 612 can allow the computing device 600 to be logically coupled to other devices including the I/O components 614, the presentation component(s) 618, and/or other components, some of which can be built in to (e.g., integrated in) the computing device 600. Illustrative I/O components 614 include a microphone, mouse, keyboard, joystick, game pad, game controller, satellite dish, scanner, printer, wireless device, etc. The I/O components 614 can provide a natural user interface (NUI) that processes air gestures, voice, or other physiological inputs generated by a user. In some instances, inputs can be transmitted to an appropriate network element for further processing. An NUI can implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 600. The computing device 600 can be include depth cameras, such as stereoscopic camera systems, infrared camera systems, RGB camera systems, touchscreen technology, and combinations of these, for gesture detection and recognition. Additionally, the computing device 600 can include accelerometers or gyroscopes (e.g., as part of an inertia measurement unit (IMU)) that allow detection of motion. In some examples, the output of the accelerometers or gyroscopes can be used by the computing device 600 to render immersive augmented reality or virtual reality.

The power supply 616 can include a hard-wired power supply, a battery power supply, or a combination thereof. The power supply 616 can provide power to the computing device 600 to allow the components of the computing device 600 to operate.

The presentation component(s) 618 can include a display (e.g., a monitor, a touch screen, a television screen, a heads-up-display (HUD), other display types, or a combination thereof), speakers, and/or other presentation components. The presentation component(s) 618 can receive data from other components (e.g., the GPU(s) 608, the CPU(s) 606, DPUs, etc.), and output the data (e.g., as an image, video, sound, etc.).

### Example Data Center

FIG. 7 illustrates an example data center 700 that can be used in at least one implementations of the present disclosure. Generally, the example data center 700 can host the computational infrastructure to execute generative language models, vision language models, and embedding retrieval systems, facilitating real-time or near real-time processing for adaptive input generation and interaction within virtual environments. The data center 700 can include a data center infrastructure layer 710, a framework layer 720, a software layer 730, and/or an application layer 740.

As shown in FIG. 7, the data center infrastructure layer 710 can include a resource orchestrator 712, grouped computing resources 714, and node computing resources (“node C.R.s”) 716(1)-716(N), where “N” represents any whole, positive integer. In at least one implementation, node C.R.s 716(1)-716(N) can include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some implementations, one or more node C.R. s from among node C.R.s 716(1)-716(N) can correspond to a server having one or more of the above-mentioned computing resources. In addition, in some implementations, the node C.R.s 716(1)-7161(N) can include one or more virtual components, such as vGPUs, vCPUs, and/or the like, and/or one or more of the node C.R.s 716(1)-716(N) can correspond to a virtual machine (VM).

In at least one implementation, grouped computing resources 714 can include separate groupings of node C.R.s 716 housed within one or more racks (not shown), or many racks housed in data centers at various geographical locations (also not shown). Separate groupings of node C.R.s 716 within grouped computing resources 714 can include grouped compute, network, memory or storage resources that can be configured or allocated to support one or more workloads. In at least one implementation, several node C.R.s 716 including CPUs, GPUs, DPUs, and/or other processors can be grouped within one or more racks to provide compute resources to support one or more workloads. The one or more racks can also include any number of power modules, cooling modules, and/or network switches, in any combination.

The resource orchestrator 712 can configure or otherwise control one or more node C.R.s 716(1)-716(N) and/or grouped computing resources 714. In at least one implementation, resource orchestrator 712 can include a software design infrastructure (SDI) management entity for the data center 700. The resource orchestrator 712 can include hardware, software, or some combination thereof.

In at least one implementation, as shown in FIG. 7, framework layer 720 can include a job scheduler 728, a configuration manager 734, a resource manager 736, and/or a distributed file system 738. The framework layer 720 can include a framework to support software 732 of software layer 730 and/or one or more application(s) 742 of application layer 740. The software 732 or application(s) 742 can respectively include web-based service software or applications, such as those provided by Amazon Web Services, Google Cloud and Microsoft Azure. The framework layer 720 can be, but is not limited to, a type of free and open-source software web application framework such as Apache Spark™ (hereinafter “Spark”) that can use distributed file system 738 for large-scale data processing (e.g., “big data”). In at least one implementation, job scheduler 728 can include a Spark driver to facilitate scheduling of workloads supported by various layers of data center 700. The configuration manager 734 can be capable of configuring different layers such as software layer 730 and framework layer 720 including Spark and distributed file system 738 for supporting large-scale data processing. The resource manager 736 can be capable of managing clustered or grouped computing resources mapped to or allocated for support of distributed file system 738 and job scheduler 728. In at least one implementation, clustered or grouped computing resources can include grouped computing resource 714 at data center infrastructure layer 710. The resource manager 736 can coordinate with resource orchestrator 712 to manage these mapped or allocated computing resources.

In at least one implementation, software 732 included in software layer 730 can include software used by at least portions of node C.R.s 716(1)-716(N), grouped computing resources 714, and/or distributed file system 738 of framework layer 720. One or more types of software can include, but are not limited to, Internet web page search software, e-mail virus scan software, database software, and streaming video content software.

In at least one implementation, application(s) 742 included in application layer 740 can include one or more types of applications used by at least portions of node C.R.s 716(1)-716(N), grouped computing resources 714, and/or distributed file system 738 of framework layer 720. One or more types of applications can include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more implementations.

In at least one implementation, any of configuration manager 734, resource manager 736, and resource orchestrator 712 can implement any number and type of self-modifying actions based at least in part on any amount and type of data acquired in any technically feasible fashion. Self-modifying actions can relieve a data center operator of data center 700 from making possibly bad configuration decisions and possibly avoiding underutilized and/or poor performing portions of a data center.

The data center 700 can include tools, services, software or other resources to train one or more machine learning models or predict or infer information using one or more machine learning models according to one or more implementations described herein. For example, a machine learning model(s) can be trained by calculating weight parameters according to a neural network architecture using software and/or computing resources described above with respect to the data center 700. In at least one implementation, trained or deployed machine learning models corresponding to one or more neural networks can be used to infer or predict information using resources described above with respect to the data center 700 by using weight parameters calculated through one or more training techniques, such as but not limited to those described herein.

In at least one implementation, the data center 700 can use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above can be configured as a service to allow users to train or performing inferencing of information, such as image recognition, speech recognition, or other artificial intelligence services.

### Example Network Environments

Network environments suitable for use in implementing implementations of the disclosure can include one or more client devices, servers, network attached storage (NAS), other backend devices, and/or other device types. The client devices, servers, and/or other device types (e.g., each device) can be implemented on one or more instances of the computing device(s) 600 of FIG. 6—e.g., each device can include similar components, features, and/or functionality of the computing device(s) 600. In addition, where backend devices (e.g., servers, NAS, etc.) are implemented, the backend devices can be included as part of a data center 700, an example of which is described in more detail herein with respect to FIG. 7.

Components of a network environment can communicate with each other via a network(s), which can be wired, wireless, or both. The network can include multiple networks, or a network of networks. By way of example, the network can include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) can provide wireless connectivity.

Compatible network environments can include one or more peer-to-peer network environments—in which case a server cannot be included in a network environment—and one or more client-server network environments—in which case one or more servers can be included in a network environment. In peer-to-peer network environments, functionality described herein with respect to a server(s) can be implemented on any number of client devices.

In at least one implementation, a network environment can include one or more cloud-based network environments, a distributed computing environment, a combination thereof, etc. A cloud-based network environment can include a framework layer, a job scheduler, a resource manager, and a distributed file system implemented on one or more of servers, which can include one or more core network servers and/or edge servers. A framework layer can include a framework to support software of a software layer and/or one or more application(s) of an application layer. The software or application(s) can respectively include web-based service software or applications. In implementations, one or more of the client devices can use the web-based service software or applications (e.g., by accessing the service software and/or applications via one or more application programming interfaces (APIs)). The framework layer can be, but is not limited to, a type of free and open-source software web application framework such as that can use a distributed file system for large-scale data processing (e.g., “big data”).

A cloud-based network environment can provide cloud computing and/or cloud storage that carries out any combination of computing and/or data storage functions described herein (or one or more portions thereof). Any of these various functions can be distributed over multiple locations from central or core servers (e.g., of one or more data centers that can be distributed across a state, a region, a country, the globe, etc.). If a connection to a user (e.g., a client device) is relatively close to an edge server(s), a core server(s) can designate at least a portion of the functionality to the edge server(s). A cloud-based network environment can be private (e.g., limited to a single organization), can be public (e.g., available to many organizations), and/or a combination thereof (e.g., a hybrid cloud environment).

The client device(s) can include at least some of the components, features, and functionality of the example computing device(s) 600 described herein with respect to FIG. 6. By way of example and not limitation, a client device can be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure can be practiced in a variety of system configurations, including hand-held devices, consumer electronics, general-purpose computers, more specialty computing devices, etc. The disclosure can also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” can include only element A, only element B, only element C, element A and element B, element A and element C, element B and element C, or elements A, B, and C. In addition, “at least one of element A or element B” can include at least one of element A, at least one of element B, or at least one of element A and at least one of element B. Further, “at least one of element A and element B” can include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

What is claimed is:

1. One or more processors comprising:
one or more circuits to:
capture at least one frame of an application corresponding with a viewpoint of an avatar in a virtual environment;
apply the at least one frame to at least one vision language model (VLM) to cause the at least one VLM to generate at least one scene description based at least in part on the at least one frame;
retrieve a set of embeddings based at least on a similarity metric between the generated at least one scene description and the set of embeddings, the set of embeddings comprising at least one corresponding input command of the avatar;
apply the set of embeddings to at least one large language model (LLM) to cause the at least one LLM to generate at least one input command of the avatar corresponding with updating at least one of a position or action of the avatar in the application; and
perform the at least one input command within the application to update at least one of the position or action of the avatar.

2. The one or more processors of claim 1, wherein the one or more circuits are to:
identify application data of the application;
map a plurality of frames of the application data to a plurality of avatar inputs;
generate, using the at least one VLM, a plurality of scene descriptions corresponding to the plurality of frames;
generate the set of embeddings comprising a plurality of vectors, the plurality of vectors comprising the plurality of scene descriptions and corresponding avatar inputs of the plurality of avatar inputs; and
store the set of embeddings in a vector database.

3. The one or more processors of claim 2, wherein retrieving the set of embeddings comprises:
identifying at least one vector of the plurality of vectors corresponding to at least one stored scene description of the plurality of scene descriptions, wherein the at least one vector comprises the corresponding avatar inputs of the at least one stored scene description.

4. The one or more processors of claim 1, wherein the one or more circuits are to:
initiate execution of a capture script to record a plurality of input events and corresponding timestamps during at least one game session of the application, the execution of the capture script comprising capturing the at least one frame and a plurality of additional frames; and
record the plurality of input events and corresponding timestamps to generate a log of a plurality of input commands performed by the avatar during the at least one game session.

5. The one or more processors of claim 4, wherein the one or more circuits are to:
apply at least one second VLM to cause the at least one second VLM to identify at least one visual anomaly within the virtual environment of the application, wherein identifying the at least one visual anomaly comprises the at least one second VLM detecting at least one inconsistency in at least one of physics interaction, object behavior, or visual rendering during the game session; and
associate the at least one visual anomaly with a corresponding input event of the plurality of input events, wherein the log comprises the at least one visual anomaly.

6. The one or more processors of claim 4, wherein the one or more circuits are to:
continuously capture, in real-time or near real-time, the plurality of additional frames during the at least one game session, wherein the at least one frame is captured responsive to receiving a start command in the application.

7. The one or more processors of claim 1, wherein the one or more circuits are to:
generate, using at least one neural network, a quality score of at least one of the position or action of the avatar;
wherein the at least one input command is performed responsive to the quality score satisfying a predetermined threshold.

8. The one or more processors of claim 1, wherein the update to at least one of the position or action of the avatar comprises avoiding a visual obstacle within the virtual environment of the application.

9. The one or more processors of claim 8, wherein the application generates the at least one frame of a rendering in the virtual environment, and wherein the at least one scene description generated by the at least one VLM identifies at least one object or environmental feature within the virtual environment.

10. The one or more processors of claim 1, wherein retrieving the set of embeddings comprises using retrieval-augmented generation (RAG), and wherein the at least one input command is agnostic to the application or a game engine executing the application.

11. The one or more processors of claim 1, wherein the one or more processors are comprised in at least one of:
a control system for an autonomous or semi-autonomous machine;
a perception system for an autonomous or semi-autonomous machine;
a system implemented using a robot;
an aerial system;
a medical system;
a boating system;
a smart area monitoring system;
a system for performing deep learning operations;
a system for performing simulation operations;
a system for generating or presenting virtual reality (VR) content, augmented reality (AR) content, or mixed reality (MR) content;
a system for performing digital twin operations;
a system implemented using an edge device;
a system incorporating one or more virtual machines (VMs);
a system for generating synthetic data;
a system implemented at least partially in a data center;
a system for performing conversational artificial intelligence (AI) operations;
a system for performing generative AI operations;
a system implementing language models;
a system implementing vision language models (VLMs);
a system implementing large language models (LLMs);
a system implementing small language models (SLMs);
a system implementing multi-modal language models (MMLMs);
a system for hosting one or more real-time streaming applications;
a system for performing light transport simulation;
a system for performing collaborative content creation for 3D assets; or
a system implemented at least partially using cloud computing resources.

12. A system, comprising:
one or more processors to:
cause at least one first model to generate at least one scene description based at least in part on at least one frame of an application corresponding to an avatar in an environment;
retrieve a set of embeddings based at least on a similarity metric between the generated at least one scene description and the set of embeddings, the set of embeddings comprising at least one corresponding input command of the avatar;
cause at least one second model to generate at least one input command of the avatar corresponding with updating at least one of a position or action of the avatar in the application based at least on the set of embeddings comprising the at least one corresponding input command; and
perform the at least one input command within the application to update at least one of the position or action of the avatar.

13. The system of claim 12, wherein the one or more processors are to:
identify application data of the application;
map a plurality of frames of the application data to a plurality of avatar inputs;
generate, using the at least one first model, a plurality of scene descriptions corresponding to the plurality of frames;
generate the set of embeddings comprising a plurality of vectors, the plurality of vectors comprising the plurality of scene descriptions and corresponding avatar inputs of the plurality of avatar inputs; and
store the set of embeddings in a vector database.

14. The system of claim 13, wherein retrieving the set of embeddings comprises:
identifying at least one vector of the plurality of vectors corresponding to at least one stored scene description of the plurality of scene descriptions, wherein the at least one vector comprises the corresponding avatar inputs of the at least one stored scene description.

15. The system of claim 12, wherein the one or more processors are to:
initiate execution of a capture script to record a plurality of input events and corresponding timestamps during at least one session of the application, the execution of the capture script comprising capturing the at least one frame and a plurality of additional frames; and
record the plurality of input events and corresponding timestamps to generate a log of a plurality of input commands performed by the avatar during the at least one session.

16. The system of claim 15, wherein the one or more processors are to:
apply at least one third model to cause the at least one third model to identify at least one visual anomaly of the application, wherein identifying the at least one visual anomaly comprises the at least one third model detecting at least one inconsistency in at least one of physics interaction, object behavior, or visual rendering during a game session; and
associate the at least one visual anomaly with a corresponding input event of the plurality of input events, wherein the log comprises the at least one visual anomaly.

17. The system of claim 15, wherein the one or more processors are to:
continuously capture, in real-time or near real-time, the plurality of additional frames during the at least one session, wherein the at least one frame is captured responsive to receiving a start command in the application.

18. The system of claim 12, wherein the one or more processors are to:
generate, using at least one neural network, a quality score of at least one of the position or action of the avatar;
wherein the at least one input command is performed responsive to the quality score satisfying a predetermined threshold.

19. The system of claim 12, wherein the update to at least one of the position or action of the avatar comprises avoiding a visual obstacle of the application.

20. A method, comprising:
generating, by one or more processors, at least one scene description based at least in part on at least one frame corresponding to a state within an application;
obtaining, by the one or more processors, at least one embedding for the generated at least one scene description based at least on a similarity metric between the generated at least one scene description and the at least one embedding;
applying, by the one or more processors, the at least one embedding to at least one model to generate at least one command to update the state within the application; and
executing the at least one command to update the state within the application.
